(19) United States
(12) Patent Application Publication
(10) Pub. No.: US 2015/0193809 A1
(43) Pub. Date: Jul. 9, 2015

(54) Do Not Track / Advertise Functionality Based on User Identification Association

(71) Applicant: CenturyLink Intellectual Property LLC, Denver, CO (US)

(72) Inventor: Michael K. Bugenhagen, Overland Park, KS (US)

(21) Appl. No.: 14/532,270

(22) Filed: Nov. 4, 2014

Related U.S. Application Data
(60) Provisional application No. 61/924,043, filed on Jan. 6, 2014.

(51) Int. Cl. G06Q 30/02

(52) U.S. Cl. CPC G06Q 30/0241

(57) ABSTRACT

Novel tools and techniques are provided for implementing user identification association functionality. In some embodiments, methods and systems might implement do not track and/or do not advertise functionality or “track me” and/or “advertise to me” functionality, based on user identification association. In some cases, a computer might receive at least one user identifier associated with a user and might determine whether the at least one user identifier is included in a do not track or do not advertise list. If the user is listed in the do not track or do not advertise list, the computer might send a notification to the requesting party indicating that the user should be removed from any tracking lists or advertising lists. If the user is listed in a “track me” list or “advertise to me” list, the computer might send another notification to the requesting party indicating that the user should be compensated.

### CROSS-REFERENCES TO RELATED APPLICATIONS

This application claims priority to U.S. Patent Application Ser. No. 61/924,043 (the “'043 application”), filed Jan. 6, 2014 by Michael K. Bugenhagen (attorney docket no. 020370-015201US), entitled, “Do Not Track/Advertise Function for Web Browsers,” the entire disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and computer software for implementing user identification association functionality, and, more particularly, to methods, systems, and computer software for implementing do not track/do not advertise functionality or “track me”/“advertise to me” functionality (e.g., for web browsers), based on user identification association.

### BACKGROUND

At present, consumer protection mechanisms exist for protecting consumers from unwanted telephone calls or unwanted mail—namely, local/national do not call or do not mail lists, respectively. However, there is currently no similar consumer protection mechanism for protecting consumers against user tracking or against other forms of advertising, at least at the local/national level. Conventional do not track mechanisms are available merely through downloading of do not track cookies by users seeking such do not track mechanisms. Enforcement of do not track or do not advertise provisions are thus extremely difficult to implement due to difficulties arising from checking of individual devices that may or may not have the proper do not track cookies, or the like. Certainly, current mechanisms do not take one or more user identifiers associated with a user to determine other (if not all) user identifiers associated with the user, and subsequently utilizing all known user identifiers (through such user identifier association techniques) to determine whether the user (or any of these user identifiers) are listed in local/national do not call, do not mail, do not track, or do not advertise lists.

Further, current systems do not allow for letting those users who would like to be tracked, or advertised to, to be searched against “track me” or “advertise to me” lists (which also do not currently exist at the national or local/regional levels) to determine whether such users should be compensated. In other words, there are no external “track me” or “advertise to me” list maintained by objective, unbiased parties (e.g., government agency, Internet service provider, watchdog groups, etc.), against which mailing list or other promotional advertising list may be maintained by individual companies or the like.

In addition, in the context of document handling, there does not appear to be any existing mechanisms for blocking access to (or deleting or moving to secure storage areas) documents that are associated with users, based on user identifiers and based on determinations that the users no longer have any rights to such documents.

Hence, there is a need for more robust and scalable solutions for preventing tracking and/or advertising directed at particular users who desire not to be tracked or advertised to, while arranging compensation to those users who desire to be tracked or advertised to. These is also a need for more robust and scalable solutions for handling documents and/or information that are associated with particular users but stored on data stores owned by, associated with, and/or maintained by a party other than the particular users.

### BRIEF SUMMARY

Various embodiments provide techniques for implementing do not track or do not advertise functionality, for implementing “track me” or “advertise to me” functionality, and/or for implementing document handling in the case of documents associated with particular users.

In some embodiments, novel tools and techniques might be provided for implementing user identification association functionality. One such method includes the maintenance of a centralized “do no track” list that can be distributed globally, with each provider—regardless of it being an Internet service provider (“ISP”), a content provider, or other Internet consumer or agent—having its own local list coordinated with the central list. The track/do not track list servers may act in concert or individually to register and store the privacy policy settings for an individual and/or agency. According to some embodiments, a key tracking server registry system allows Internet consumers and agents to apply policy equally, and, to some degree, allows the tracking of customer treatment via logging of customer tracking log registration, and tracking of how the policy was applied by the other servers providing services to customers.

In some cases, methods and systems might implement do not track and/or do not advertise functionality or “track me” and/or “advertise to me” functionality, based on user identification association. In some cases, a computer might receive at least one user identifier associated with a user and might determine whether the at least one user identifier is included in a do not track or do not advertise list (which might be local and/or national lists, or might otherwise be universal lists). If the user is listed in the do not track or do not advertise list, the computer might send a notification to the requesting party indicating that the user should be removed from any tracking lists or advertising lists. If the user is listed in a “track me” list or “advertise to me” list, the computer might send another notification to the requesting party indicating that the user should be compensated.

According to some embodiments, user identification association functionality might be used to identify documents and/or information that are associated with the user but are stored on data stores associated with, operated by, and/or maintained by a party other than the user. A non-limiting example of situations in which such document handling might be useful might include situations involving former employees and documents and/or information associated with the former employees that are stored on the employer's data stores. If the employer has rights to the documents and/or the information (e.g., work product or work-related documents, and/or the like), then the employer might request the system to block access to the documents and/or the information by the former employees. If the employee has rights to the documents and/or the information (e.g., personal documents or personal information, and/or the like), then the system might delete the documents and/or information. Such employer/employee situations, however, are merely for illustration, and the various embodiments pertaining to document handling are not limited to such situations.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In an aspect, a method might comprise receiving, with a first computer from a requesting party, at least one user identifier associated with a particular user, and determining, with the first computer, whether the at least one user identifier is included in a first list. The method might further comprise, based on a determination that the at least one user identifier is included in the first list, sending, with the first computer, a first notification to the requesting party. The first notification might indicate that the particular user associated with the at least one user identifier should be removed from one or more of user tracking lists or advertising target lists.

In some embodiments, the first computer might be a server operated by an Internet service provider, and might be located within a network associated with the Internet service provider. In some cases, the first computer might be a computer associated with a government agency registry of at least one of do not advertise user identities or do not track user identities. According to some embodiments, the requesting party might be a web server associated with a website visited by the particular user. In some instances, the requesting party might be an advertiser affiliated with companies with which the particular user has interacted to search, inquire, or purchase products or services offered by the companies.

Merely by way of example, in some cases, the at least one user identifier might include one or more identification information selected from a group consisting of one or more names of the particular user, one or more usernames of the particular user, one or more telephone numbers associated with the particular user, one or more e-mail addresses associated with the particular user, a social security number associated with the particular user, a tax identification number associated with the particular user, a passport number associated with the particular user, one or more bank accounts associated with the particular user, one or more universal resource locator (“URL”) addresses associated with the particular user, one or more metadata associated with the particular user, one or more documents associated with the particular user, one or more devices associated with the particular user, one or more device identifiers associated with a device associated with the particular user, one or more Internet protocol (“IP”) addresses associated with devices associated with the particular user, one or more IP addresses associated with the particular user, and one or more media access control (“MAC”) addresses associated with at least one device associated with the particular user, and/or the like.

In some cases, the first list might be at least one of a national do not track list or a national do not advertise list. Alternatively, the first list might be at least one of a local do not track list or a local do not advertise list. In some instances, the at least one of a local do not track list or a local do not advertise list might be maintained by an ISP.

In some embodiments, the method might further comprise receiving, with a second computer associated with the requesting party, the first notification, and accessing, with the second computer, the one or more of user tracking lists or advertising target lists. The method might also comprise determining, with the second computer, whether one or more of the at least one user identifier associated with the particular user, another user identifier associated with the particular user, or the particular user are included in the one or more of user tracking lists or advertising target.

According to some embodiments, the method might further comprise, based on a determination that the one or more of the at least one user identifier associated with the particular user, another user identifier associated with the particular user, or the particular user are included in the one or more of user tracking lists or advertising target lists, applying, with the second computer, internal data processing rules to ensure national policy adherence. In some instances, applying, with the second computer, internal data processing rules to ensure national policy adherence might comprise removing, with the second computer and from the one or more of user tracking lists or advertising target lists, all user identifiers associated with the particular user.

In some cases, the method might further comprise, based on a determination that the one or more of the at least one user identifier associated with the particular user, another user identifier associated with the particular user, or the particular user are included in the one or more of user tracking lists or advertising target lists, reporting, with the second computer, one or more organizations associated with one or more of user tracking lists or advertising target lists, as failing to comply with at least one of a do not track list or a do not advertise list.

According to some aspects, the method might further comprise receiving, with a third computer associated with the requesting party, the first notification, and generating, with the third computer, a new code setting associated with the particular user. The new code setting might include at least one of one or more do not track cookies or one or more do not advertise cookies. The method might also comprise identifying, with the third computer, one or more user devices associated with the particular user, and sending, with the third computer, the new code setting to each of the one or more user devices associated with the particular user.

In some instances, the method might further comprise receiving, with a fourth computer, a first request from the particular user to be included in the first list, the first request including the at least one user identifier. The method might also comprise adding the at least one user identifier to the first list. In some cases, adding the at least one user identifier to the first list might comprise sending, with the fourth computer, a second request to a party maintaining the first list to include the at least one user identifier to the first list. Herein, any two or more of the first through fourth computers might be the same computer.

In some embodiments, the method might comprise, based on a determination that the at least one user identifier is not included in the first list, determining, with the first computer, whether the at least one user identifier is included in a second list. In some instances, the method might further comprise, based on a determination that the at least one user identifier is included in the second list, sending, with the first computer, a second notification to the requesting party. The second notification might indicate that the particular user associated with the at least one user identifier should be given compensation for inclusion in one or more of user tracking lists or advertising target.

According to some embodiments, the compensation might include one or more of a promotion on products purchased by the particular user from a first company affiliated with the one or more of user tracking lists or advertising target lists or a promotion on services purchased by the particular user from the first company affiliated with the one or more of user tracking lists or advertising target lists. The promotion on products and the promotion on services might each include one or more of a discount on purchase of one or more of the products, a discount on purchase of one or more of the services, a subsidy for purchase of one or more of the products, a subsidy for purchase of one or more of the services, a discount on purchase of one or more products offered by a second company affiliated with the first company, a discount on purchase of one or more services offered by the second company affiliated with the first company, a subsidy on purchase of one or more products offered by a second company affiliated with the first company, or a subsidy on purchase of one or more services offered by the second company affiliated with the first, and/or the like.

In another aspect, an apparatus might comprise at least one processor and at least one non-transitory computer readable medium. The at least one non-transitory computer readable medium might have encoded thereon software, which might include a set of instructions that, when executed by the at least one processor, causes the apparatus to perform one or more operations. The set of instructions might comprise instructions to receive, from a requesting party, at least one user identifier associated with a particular user and instructions to determine whether the at least one user identifier is included in a first list. The set of instructions might further comprise instructions to send, based on a determination that the at least one user identifier is included in the first list, a first notification to the requesting party. The first notification might indicate that the particular user associated with the at least one user identifier should be removed from one or more of user tracking lists or advertising target lists.

In yet another aspect, a method might comprise receiving, with a first computer from a requesting party, at least one user identifier associated with a particular user, and identifying, with the first computer, one or more first documents associated with the particular user that are stored in one or more data stores, based at least in part on the received at least one user identifier. The one or more data stores might be associated with a party other than the particular user. The method might also comprise identifying, with the first computer, one or more second documents to which the party other than the particular user has rights, the one or more second documents being identified from among the one or more first documents. The method might further comprise receiving, with the first computer, a request from the party other than the particular user to block access by the particular user to the one or more second documents stored in the one or more data stores, and preventing, with the first computer, access by the particular user to the one or more second documents stored in the one or more data stores, in response to receiving, from the party other than the particular user, the request to block access.

According to some embodiments, the method might further comprise identifying, with the first computer, one or more third documents to which the party other than the particular user has no rights, the one or more third documents being identified from among the one or more first documents. The method might also comprise deleting, with the first computer, the one or more third documents from the one or more data stores.

Alternatively, in some embodiments, the method might further comprise identifying, with the first computer, one or more third documents to which the party other than the particular user has no rights, the one or more third documents being identified from among the one or more first documents. The method might also comprise establishing, with the first computer, one or more secure portions of the one or more data stores, moving, with the first computer, the one or more third documents to the one or more secure portions of the one or more data stores, and providing the user with access to the one or more secure portions of the one or more data stores.

In some cases, the party other than the particular user might comprise one of an employer of the particular user, a former employer of the particular user, a bank serving the particular user who is a customer of the bank, a bank serving the particular user who is a former customer of the bank, a school that allows the particular user as a student to store documents or data, or a school that had allowed the particular user to store documents or data when the particular user was a student, and/or the like.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a general schematic diagram illustrating a system for implementing do not track or do not advertise functionality, for implementing “track me” or “advertise to me” functionality, and/or for implementing document handling in the case of documents associated with particular users, in accordance with various embodiments.

FIG. 2 is a general schematic diagram illustrating an alternative system implementing do not track or do not advertise functionality, for implementing “track me” or “advertise to me” functionality, and/or for implementing document handling in the case of documents associated with particular users, in accordance with various embodiments.

FIGS. 3A-3C are flow diagrams illustrating various methods for implementing do not track or do not advertise functionality, in accordance with various embodiments.

FIGS. 4A and 4B are flow diagrams illustrating various methods for adding at least one user identifier associated with a user to a do not track list or a do not advertise list, in accordance with various embodiments.

FIG. 5 is a flow diagram illustrating a method for implementing “track me” or “advertise to me” functionality, in accordance with various embodiments.

FIGS. 6A-6D represent a system flow diagram illustrating a method for implementing do not track or do not advertise functionality and for implementing “track me” or “advertise to me” functionality, in accordance with various embodiments.

FIG. 7 is a flow diagram illustrating a method for implementing document handling with respect to documents associated with particular users, in accordance with various embodiments.

FIG. 8 is a block diagram illustrating an exemplary computer architecture, in accordance with various embodiments.

FIG. 9 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments provide techniques for implementing user identification association functionality, and, more particularly, to methods, systems, and computer software for implementing do not track/do not advertise functionality or “track me”/“advertise to me” functionality (e.g., for web browsers), based on user identification association. In some embodiments, techniques may be provided for implementing document handling for documents associated with particular users, based on user identification association.

In some embodiments, novel tools and techniques might be provided for implementing user identification association functionality. In some cases, methods and systems might implement do not track and/or do not advertise functionality or “track me” and/or “advertise to me” functionality, based on user identification association. In some cases, a computer might receive at least one user identifier associated with a user and might determine whether the at least one user identifier is included in a do not track or do not advertise list (which might be local and/or national lists, or might otherwise be universal lists). According to some embodiments, the computer might identify other user identifiers associated with the user based at least in part on the at least one user identifier, and might determine whether the other user identifiers are included in the local/national do not track or do not advertise lists. If the user (or any of the user identifiers associated with the user) is listed in the do not track or do not advertise list, the computer might send a notification to the requesting party indicating that the user should be removed from any tracking lists or advertising lists. If the user is listed in a “track me” list or “advertise to me” list, the computer might send another notification to the requesting party indicating that the user should be compensated. If the user is not listed on any of these lists, then the system might prompt the user as to whether the user would like to be tracked or not, and/or whether the user would like to be advertised to or not, and to perform actions accordingly (as described herein).

In some cases, the computer might be associated with, operated by, and/or maintained by an Internet service provider (“ISP”). In some instances, the computer might be associated with operated by, and/or maintained by a government agency (which may or may not maintain the local or national do not track list or do not advertise list). The requesting party might be a vendor, an advertiser, or tracking company which might be checking the user and/or the user's user identities against do not track or do not advertise lists in an attempt to remain compliant with such lists. In some instances, the requesting party might be an ISP, a government agency, a watchdog group, and/or other third party performing audits on companies that track, or advertise to, the user (who might be or whose user identifier(s) might be determined to be listed in do not track and/or do not advertise lists).

According to some embodiments, user identification association functionality might be used to identify documents and/or information that are associated with the user but are stored on data stores associated with, operated by, and/or maintained by a party other than the user. A non-limiting example of situations in which such document handling might be useful might include situations involving former employees and documents and/or information associated with the former employees that are stored on the employer's data stores. If the employer has rights to the documents and/or the information (e.g., work product or work-related documents, and/or the like), then the employer might request the system to block access to the documents and/or the information by the former employees. If the employee has rights to the documents and/or the information (e.g., personal documents or personal information, and/or the like), then the system might delete the documents and/or information.

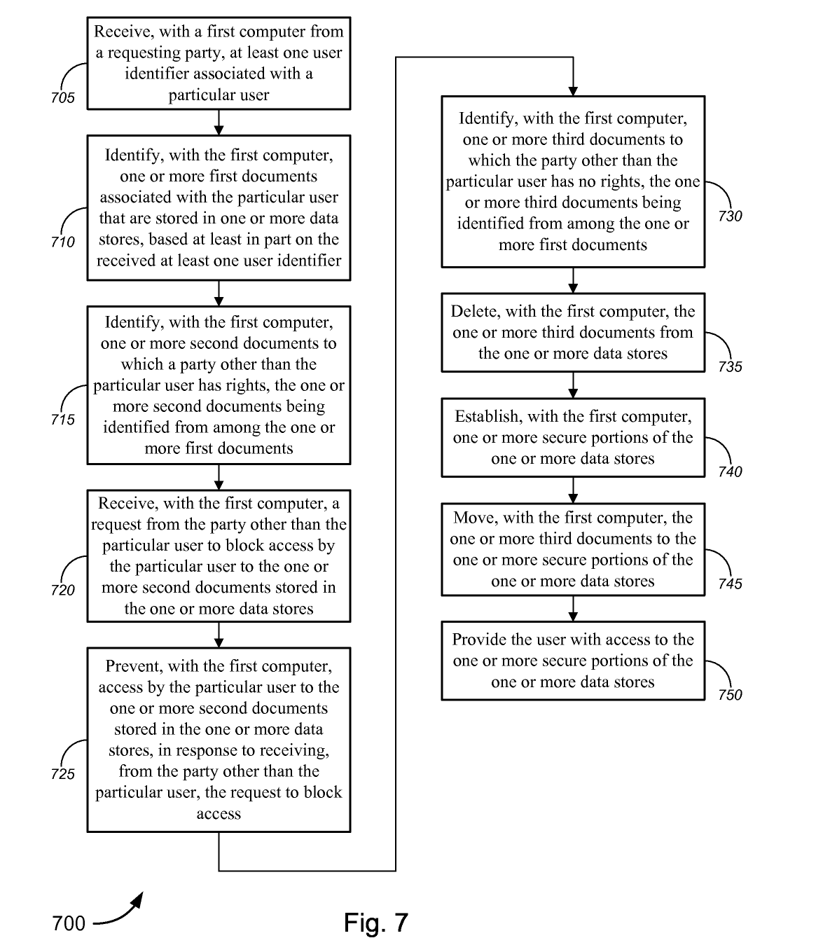

In the case of current employment, if the employer has rights to the documents and/or the information (but the employee does not or no longer has access), then the employer might request the system to block access to the documents and/or the information by the employee. If the employee has rights to the documents and/or the information (but the employer does not), then the system might establish a secure portion of the data store, move the documents and/or information to the secure portion of the data store, and provide the employee with access (or options to access) the secure portion of the data store. These and other implementation of the document handling functionality are not limited to the context of employer/employee, but may be similarly applicable to school/student, bank/customer, company/guest, and so on (as described in detail below with respect to FIG. 7.

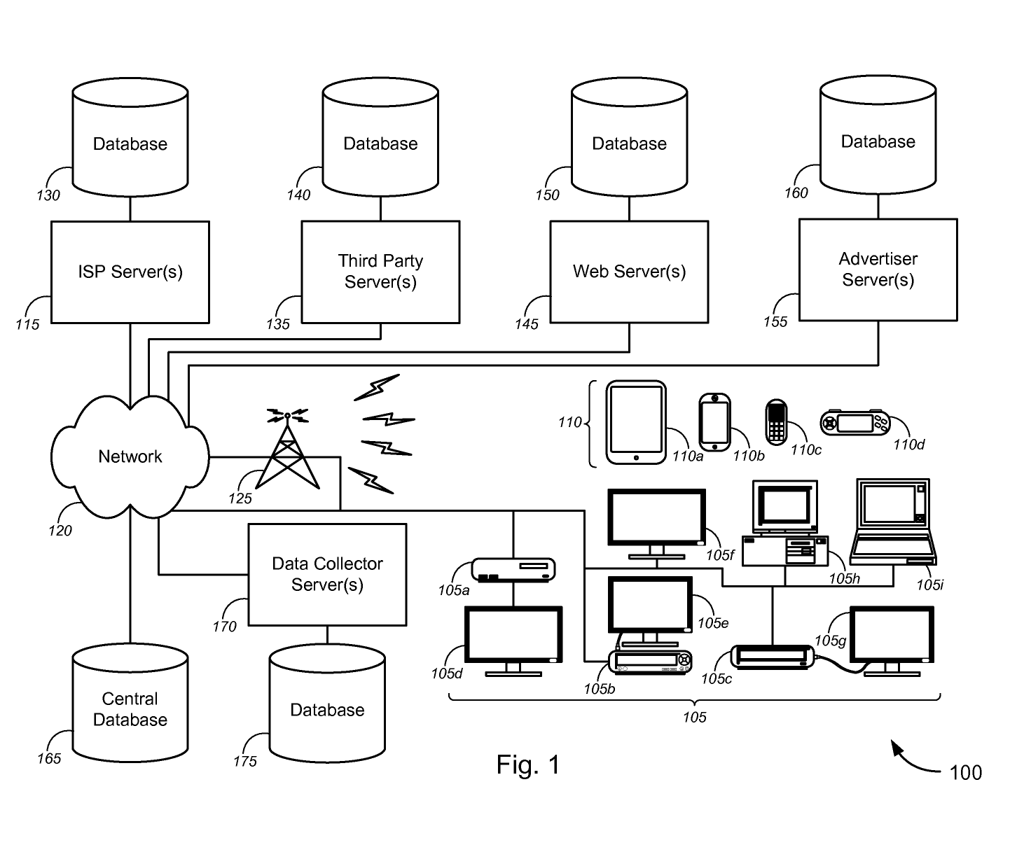

We now turn to the embodiments as illustrated by the drawings. FIGS. 1-9 illustrate some of the features of the method, system, and apparatus for implementing do not track or do not advertise functionality, for implementing “track me” or “advertise to me” functionality, and/or for implementing document handling in the case of documents associated with particular users, as referred to above. The methods, systems, and apparatuses illustrated by FIGS. 1-9 refer to examples of different embodiments that include various components and steps, which can be considered alternatives or which can be used in conjunction with one another in the various embodiments. The description of the illustrated methods, systems, and apparatuses shown in FIGS. 1-9 is provided for purposes of illustration and should not be considered to limit the scope of the different embodiments.

With reference to the figures, FIG. 1 is a general schematic diagram illustrating a system 100 for implementing do not track or do not advertise functionality, for implementing “track me” or “advertise to me” functionality, and/or for implementing document handling in the case of documents associated with particular users, in accordance with various embodiments. In FIG. 1, system 100 might comprise one or more user devices 105 associated with a user. The one or more user devices 105 might comprise gaming console 105a, digital video recording and playback device (“DVR”) 105b, set-top or set-back box (“STB”) 105c, one or more television sets (“TVs”) 105d-105g, desktop computer 105h, laptop computer 105i, and one or more mobile user devices 110. The one or more TVs 105d-105g might include any combination of a high-definition (“HD”) television, an Internet Protocol television (“IPTV”), and a cable television, or the like, where one or both of HDTV and IPTV may be interactive TVs. The one or more mobile user devices 110 might comprise one or more tablet computers 110a, one or more smart phones 110b, one or more mobile phones 110c, or one or more portable gaming devices 110d, and/or the like.

System 100 might further comprise an Internet service provider (“ISP”) server(s) 115 communicatively coupled to the one or more user devices 105 via network 120, and in some cases via one or more telecommunications relay systems 125. The one or more telecommunications relay systems 125 might include, without limitation, one or more wireless network interfaces (e.g., wireless modems, wireless access points, and the like), one or more towers, one or more satellites, and the like. System 100 might further comprise database(s) 130 in communication with ISP server(s) 115.

In some embodiments, system 100 might further comprise third party server(s) 135 that are associated with government agencies or non-governmental organizations (e.g., private or public companies, watch-dog groups, for profit or non-profit companies, and/or the like). In some cases, database(s) 140 might be communicatively coupled with third party server(s) 135. According to some embodiments, system 100 might also comprise web server(s) 145 that are associated with vendors or service providers. The web server(s) 145 might, in some instances, be communicatively coupled with database(s) 150.

In some cases, system 100 might further comprise advertiser server(s) 155 that are associated with an advertiser (among a plurality of advertisers) and/or a tracking company, or the like. The advertiser might be one or more of a phone-based telemarketer, a text message-based telemarketer, an e-mail-based telemarketer, a web-based telemarketer, a newsletter-based telemarketer, a social media-based telemarketer, and/or other type of advertiser. In some cases, the tracking company might include a company that tracks what products and/or services a (particular) user (among other users) purchase, what websites the user visits or frequently visits, what physical locations the user visits or frequent visits, who the user communicates with or typically communicates with, and/or the like for the purpose of informing advertising decisions targeted toward the user. In some cases, the advertiser and the tracking company might be separate yet collaborative companies, while in other cases the advertiser and the tracking company might be part of a single company or organization. Each of the third party server(s) 135, the web server(s) 145, and/or the advertiser server(s) 155 might be (individually) communicatively coupled with network 120.

In some embodiments, system 100 might further comprise a central database 165 in communication with network 120. The central database might store (in a central location) at least one of one or more user identifiers associated with the user, one or more do not track lists, one or more do not advertise lists, one or more “track me” lists, one or more “advertise to me” lists, and/or the like. In some cases, at least some of one or more user identifiers associated with the user, one or more do not track lists, one or more do not advertise lists, one or more “track me” lists, one or more “advertise to me” lists, and/or the like might be stored locally in one or more of databases 130, 140, 150, and/or 160. According to some embodiments, each of the one or more do not track lists, one or more do not advertise lists, one or more “track me” lists, and/or one or more “advertise to me” lists might be a universal list.

Merely by way of example, in some cases, system 100 might further comprise data collector server(s) 170, which might be communicatively coupled with network 120 and with database 175. Data collector server(s) 170, which are associated with data collectors, might monitor user interactions with websites, web servers, vendors, search engines, web browsers, and/or the like to determine whether the user interactions indicate that the user prefers to be included in a do not track list and/or a do not advertise list or included in a “track me” list and/or an “advertise to me” list, or the like. In this manner, the data collectors differ from the tracking companies, although both essentially track user interactions. Further, if the user (and/or her user identifier(s) is listed in a do not track list), data collectors would not track the user, whereas, tracking companies might have to be policed to ensure they do not track the user.

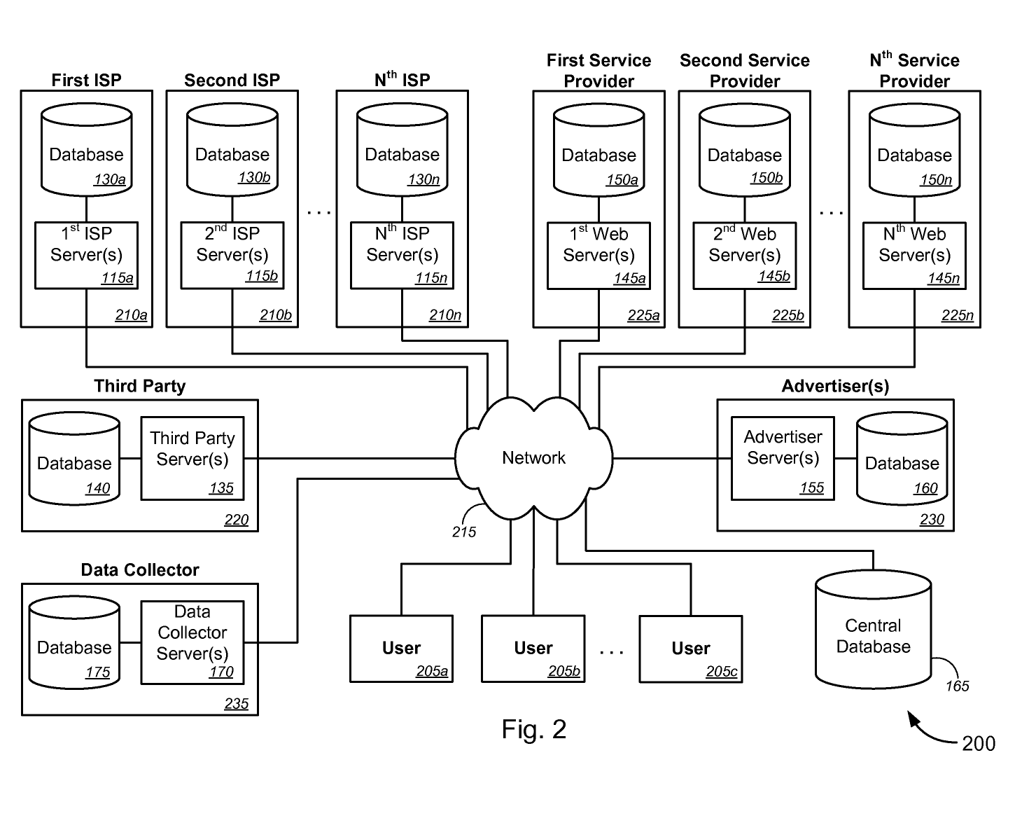

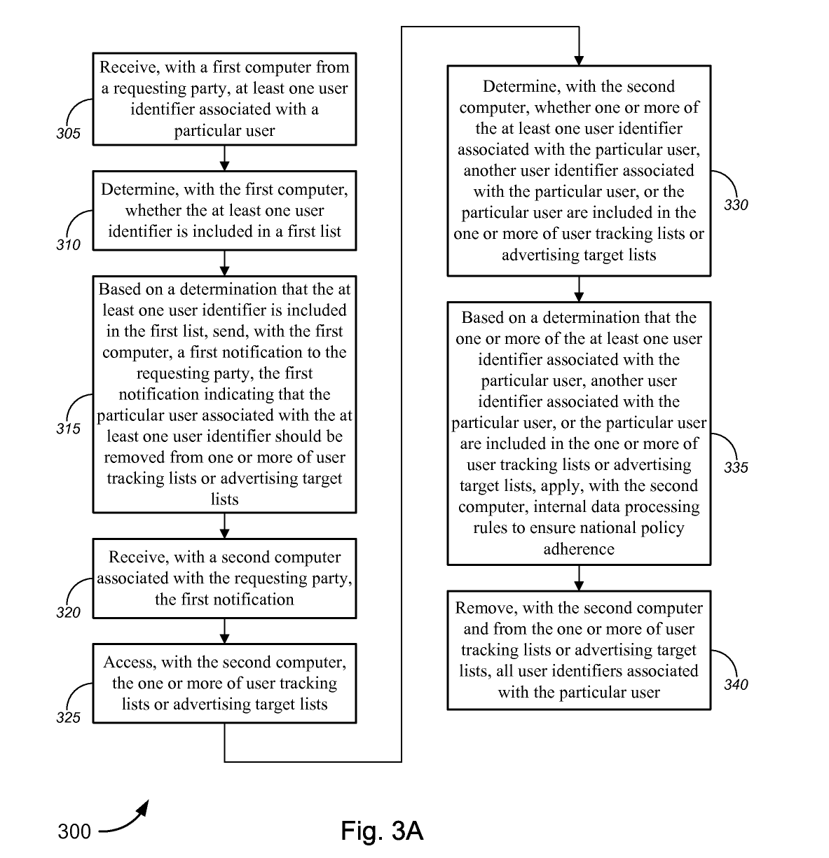

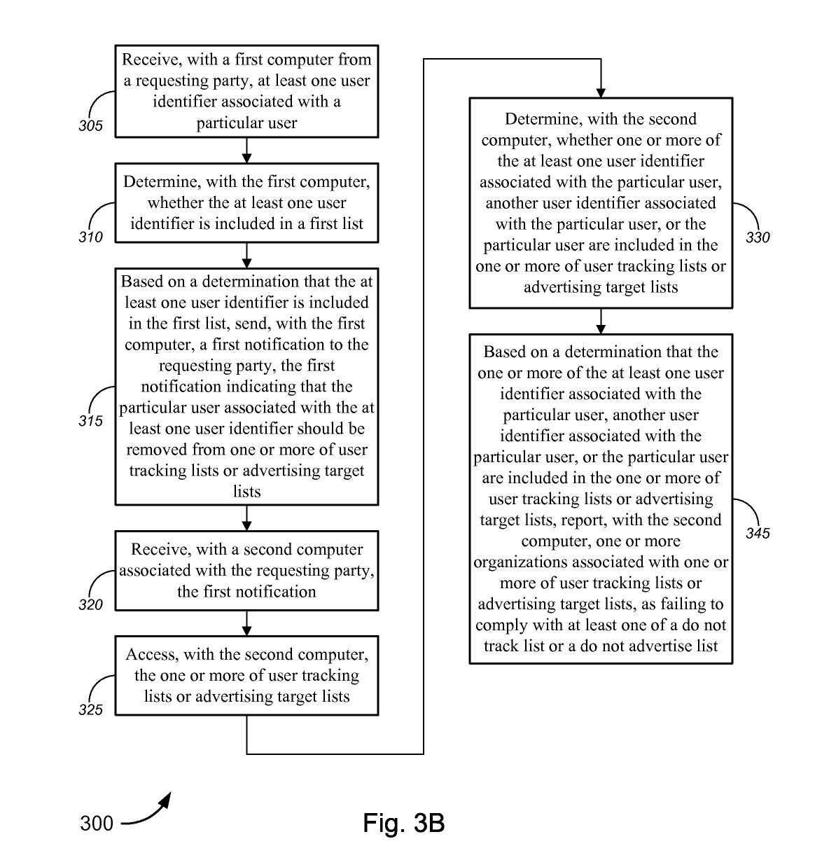

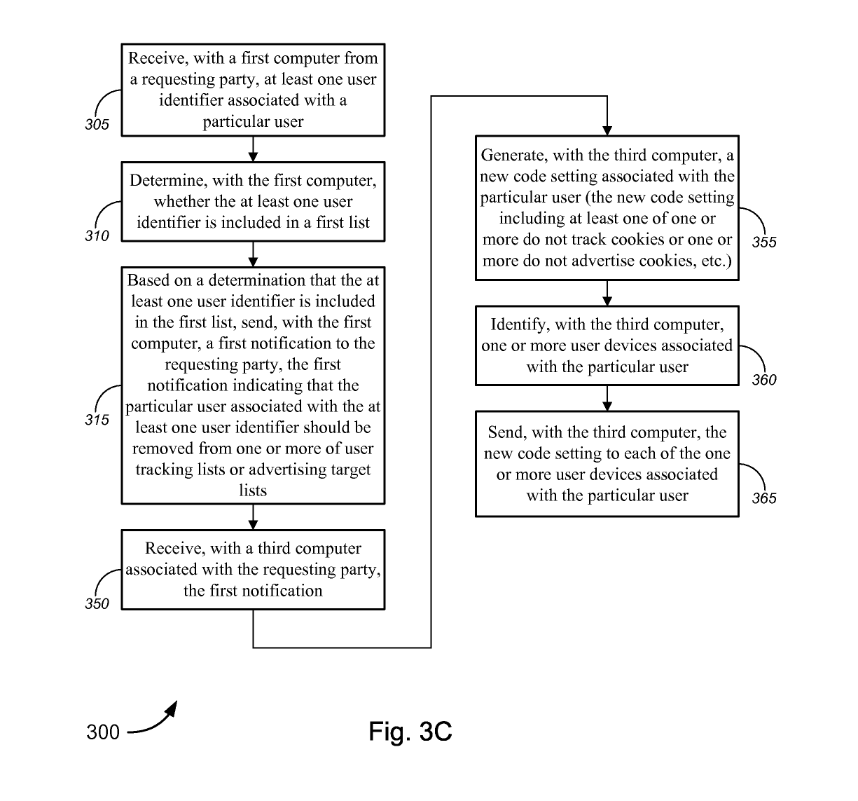

In operation, one or more of the ISP server(s) 115, the third party server(s) 135, the web server(s) 145, the advertiser server(s) 155, and/or the data collector server(s) 170 might perform the methods described in detail with respect to FIGS. 3-7 below. In some embodiments, a centralized “do no track” list may be maintained, e.g., in central database 165 or the like, and the centralized “do not track” list can be distributed globally, with each provider—regardless of the provider being an ISP, a content provider, or other Internet consumer or agent—having its own local list (which may be stored in databases 130a-130n as shown in FIG. 2) coordinated with the central list. The track/do not track list servers (e.g., one or more of the ISP server(s) 115, the third party server(s) 135, the web server(s) 145, the advertiser server(s) 155, and/or the data collector server(s) 170, or the like) may act in concert or individually to register and store the privacy policy settings for an individual and/or agency. According to some embodiments, a key tracking server registry system (which, in some cases, might run on any of the servers described above, or the like) might allow Internet consumers and agents to apply policy equally, and, to some degree, might allow the tracking of customer treatment via logging of customer tracking log registration, and tracking of how the policy was applied by the other servers providing services to customers.

FIG. 2 is a general schematic diagram illustrating an alternative system 200 implementing do not track or do not advertise functionality, for implementing “track me” or “advertise to me” functionality, and/or for implementing document handling in the case of documents associated with particular users, in accordance with various embodiments. In the embodiment shown in FIG. 2, system 200 might comprise one or more users 205a-205n (collectively, “users 205”), one or more ISPs 210a-210n (collectively, “ISPs 210”), network 215, a third party 220, one or more service providers 225a-225n (collectively, “service providers 225”), an advertiser(s) 230, a data collector 235, and/or a central database 165.

Here, users 205 might correspond to users who are associated with the one or more user devices 105 and mobile user devices 110, as described above with respect to FIG. 1. Network 215 might correspond to network 120 as described in detail above with respect to FIG. 1. Similarly, central database 165 might correspond to central database 165 as described in FIG. 1.

ISPs 210 might each be associated with an ISP server 115 and a database 130. For instance, a first ISP 210a might be associated with a first ISP server 115a and a database 130a, which is communicatively coupled with the first ISP server 115a, while a second ISP 210b might be associated with a second ISP server 115b and a database 130b, which is communicatively coupled with the second ISP server 115b, and an N^{th} ISP 210n might be associated with an N^{th} ISP server 115n and a database 130n, which is communicatively coupled with the N^{th} ISP server 115n, and so on. ISP servers 115a-115n might each correspond to ISP server(s) 115 in FIG. 1, while databases 130a-130n might each correspond to database 130 in FIG. 1.

Third party 220—which might include, without limitation, a government agency or a non-government agency (which might include, but is not limited to, private or public companies, watch-dog groups, for profit or non-profit companies, and/or the like)—might be associated with third party server(s) 135 and database 140, which is communicatively coupled with third party server(s) 135. Third party server(s) 135 and database 140 might correspond to third party server(s) 135 and database 140, respectively, as described above with respect to FIG. 1.

Service providers 225 might each be associated with a web server 145 and a database 150. For instance, a first service provider 225a might be associated with a first web server 145a and a database 150a, which is communicatively coupled with the first web server 145a, while a second service provider 225b might be associated with a second web server 145b and a database 150b, which is communicatively coupled with the second web server 145b, and an N^{th} service provider 225n might be associated with an N^{th} web server 145n and a database 150n, which is communicatively coupled with the N^{th} web server 145n, and so on. Web servers 145a-145n might each correspond to web server(s) 145 in FIG. 1, while databases 150a-150n might each correspond to database 150 in FIG. 1.

Advertiser(s) 230 might include, without limitation, a phone-based telemarketer, a text message-based telemarketer, an e-mail-based telemarketer, a web-based telemarketer, a newsletter-based telemarketer, a social media-based telemarketer, other type of advertiser, and/or a company that tracks what products and/or services a (particular) user (among other users) purchase, what websites the user visits or frequently visits, what physical locations the user visits or frequent visits, who the user communicates with or typically communicates with, and/or the like for the purpose of informing advertising decisions targeted toward the user. Advertiser(s) 230 might be associated with advertiser server(s) 155 and database 160, which might be communicatively coupled with advertiser server(s) 155. Advertiser server(s) 155 and database 160 might correspond to advertiser server(s) 155 and database 160, respectively, as described above with respect to FIG. 1.

Data collector 235—which might include any entity or organization that monitors user interactions with websites, web servers, vendors, search engines, web browsers, and/or the like to determine whether the user interactions indicate that the user prefers to be included in a do not track list and/or a do not advertise list or included in a “track me” list and/or an “advertise to me” list, or the like (which might be universal lists)—might be associated with a data collector server(s) 170 and a database 175, which is communicatively coupled with the data collector server(s) 170.

As shown in FIG. 2, each of the ISP servers 115, the third party server(s) 135, the web servers 145, the advertiser server(s) 155, the central database 165, and the data collector server(s) 170 is communicatively coupled to network 215, not unlike their corresponding counterpart components in FIG. 1.

In operation, according to some embodiments, the do not track list, the do not advertise list, the “track me” list, and/or the “advertise to me” list might be stored on the central database 165. In some cases, one of the ISPs 210 might copy or mirror the list(s) onto its database 130. In some embodiments, each of a plurality of ISPs 210 might copy or mirror the list(s) onto their corresponding databases 130. Any changes or updates to the list(s) on any of the central database 165, one of database 130, or the like, might be updated on the other of the central database 165, others of database 130, or the like. List(s) maintained on database 140 (such as a government registry or the like) might similarly be mirrored on database(s) 130 and/or central database 165, and any changes or updates to the list(s) on any of databases 130, 140, and 165 may be reflected in the other of the databases 130, 140, and 165, or the like.

In some cases, an ISP performing determinations of whether the user or any of the user's user identifiers are included in any of the list(s) might be similar to an ISP performing a domain name system (“DNS”) lookups for accessing websites or webpages during Internet browsing or the like.

Other than the differences highlighted above (which emphasizes the various parties and entities in relation to the various system components (e.g., servers, databases, networks, etc.)), system 200 would otherwise function in a manner that is similar, if not identical, to that of system 100 of FIG. 1. Accordingly, one or more of the ISP server(s) 115, the third party server(s) 135, the web server(s) 145, the advertiser server(s) 155, and/or the data collector server(s) 170, in operation, might perform the methods described in detail with respect to FIGS. 3-7 below.

We now turn to FIGS. 3A-3C (collectively, “FIG. 3”), which are flow diagrams illustrating various methods 300 for implementing do not track or do not advertise functionality, in accordance with various embodiments. FIG. 3A illustrates an example method in which a requesting party might be an advertiser or a tracking company, while FIG. 3B illustrates an alternative method in which the requesting party might be a government agency, a watch dog group, or other similar entity. FIG. 3C illustrates yet another alternative method in which the requesting party might be any one of an advertiser, a tracking company, a government agency, a watch dog group, or the like.

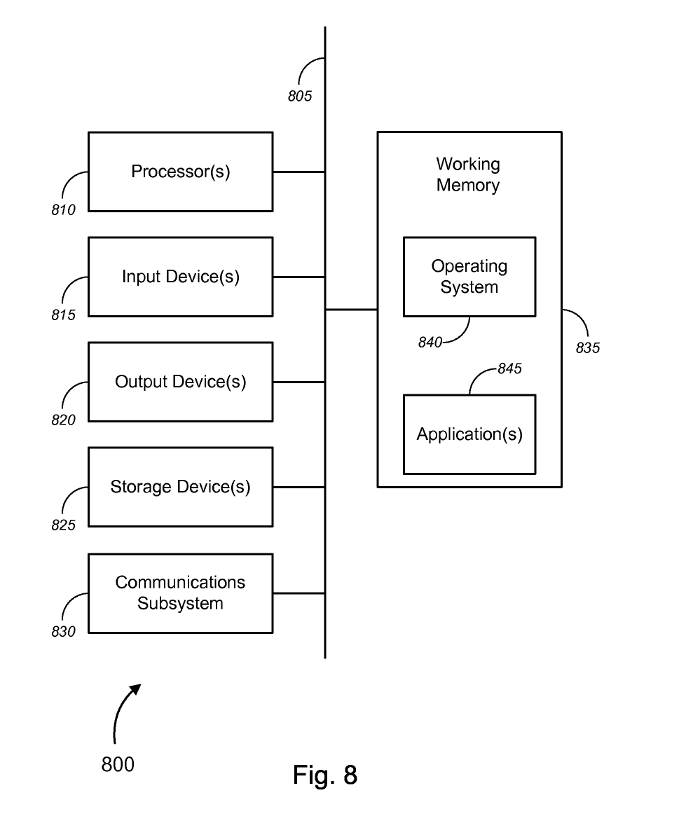

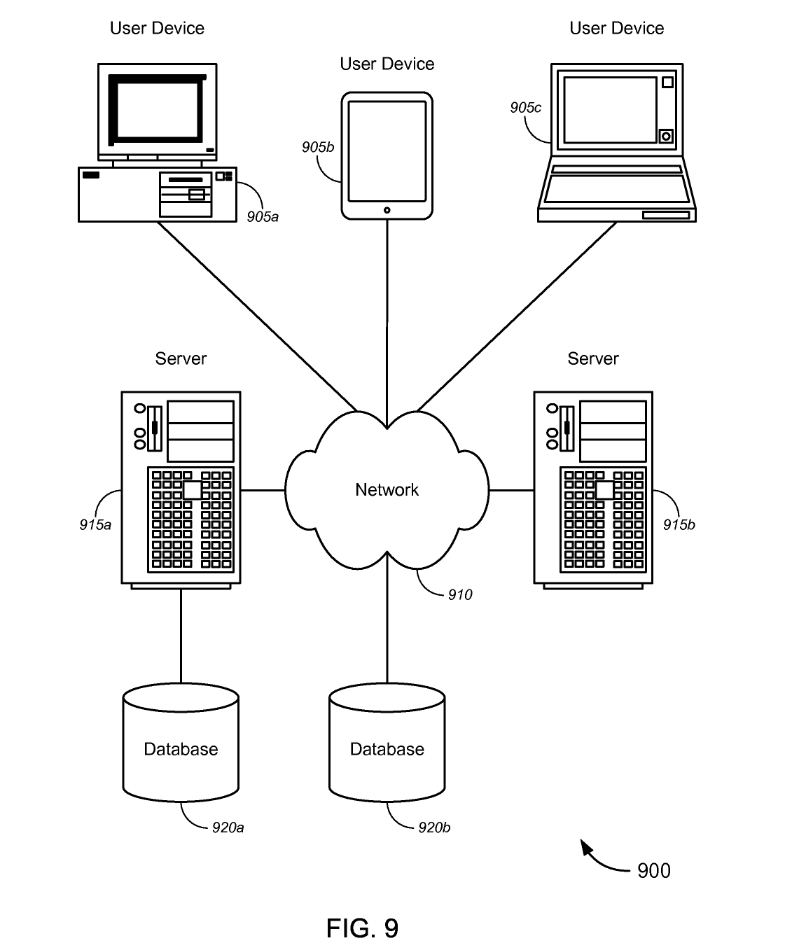

While the techniques and procedures are depicted and/or described in a certain order for purposes of illustration, it should be appreciated that certain procedures may be reordered and/or omitted within the scope of various embodiments. Moreover, while the method illustrated by FIG. 3 can be implemented by (and, in some cases, are described below with respect to) the systems 100, 200, 800, and/or 900 of FIGS. 1, 2, 8, and/or 9, respectively (or components thereof), such methods may also be implemented using any suitable hardware implementation. Similarly, while each of the system 100 (and/or components thereof) of FIG. 1, the system 200 (and/or components thereof) of FIG. 2, the system 800 (and/or components thereof) of FIG. 8, and/or the system 900 (and/or components thereof) of FIG. 9 can operate according to the method illustrated by FIG. 3 (e.g., by executing instructions embodied on a computer readable medium), the systems 100, 200, 800, and 900 can each also operate according to other modes of operation and/or perform other suitable procedures.

In FIG. 3, method 300 might comprise receiving, with a first computer from a requesting party, at least one user identifier associated with a particular user (block 305) and determining, with the first computer, whether the at least one user identifier is included in a first list (block 310). At block 315, method 300 might further comprise, based on a determination that the at least one user identifier is included in the first list, sending, with the first computer, a first notification to the requesting party, the first notification indicating that the particular user associated with the at least one user identifier should be removed from one or more of user tracking lists or advertising target lists.

In some embodiments, the at least one user identifier might include, without limitation, one or more identification information selected from a group consisting of one or more names of the particular user, one or more usernames of the particular user, one or more telephone numbers associated with the particular user, one or more e-mail addresses associated with the particular user, a social security number associated with the particular user, a tax identification number associated with the particular user, a passport number associated with the particular user, one or more bank accounts associated with the particular user, one or more universal resource locator (“URL”) addresses associated with the particular user, one or more metadata associated with the particular user, one or more documents associated with the particular user, one or more devices associated with the particular user, one or more device identifiers associated with a device associated with the particular user, one or more Internet protocol (“IP”) addresses associated with devices associated with the particular user, one or more Internet protocol addresses associated with the particular user, and/or one or more media access control (“MAC”) addresses associated with at least one device associated with the particular user, or the like.

In some cases, the first computer might be a server operated by an Internet service provider, and is located within a network associated with the Internet service provider. In other cases, the first computer might be a computer associated with a government agency registry of at least one of do not advertise user identities or do not track user identities. In some embodiments (as shown with respect to FIG. 3A), the requesting party might be a web server associated with a website visited by the particular user, an advertiser, or a tracking company. The advertiser or tracking company, might in some cases, be affiliated with companies with which the particular user has interacted to search, inquire, or purchase products or services offered by the companies. In some embodiments (as shown with respect to FIG. 3B), the requesting party might be a government agency, a watch dog organization, or the like. In some embodiments (as shown with respect to FIG. 3C), the requesting party might be any of the web server associated with the website visited by the particular user, the advertiser, the tracking company, the government agency, the watch dog organization, or other like entities or organizations.

According to some embodiments, the first list might be at least one of a national do not track list, a national do not advertise list, a local do not track list, and/or a local do not advertise list. In some cases, the at least one of a national do not track list, a national do not advertise list, a local do not track list, and/or a local do not advertise list might be maintained by an Internet service provider, by a government agency, or by a non-governmental entity, or the like.

In the embodiment of FIG. 3A, method 300 might further comprise, at block 320, receiving, with a second computer associated with the requesting party (e.g., a web server associated with a website visited by the particular user, an advertiser, or a tracking company, or the like), the first notification and, at block 325, might accessing, with the second computer, the one or more of user tracking lists or advertising target lists. At block 300, the requesting party might determining, with the second computer, whether one or more of the at least one user identifier associated with the particular user, another user identifier associated with the particular user, or the particular user are included in the one or more of user tracking lists or advertising target lists. Method 300, at block 335, might comprise, based on a determination that the one or more of the at least one user identifier associated with the particular user, another user identifier associated with the particular user, or the particular user are included in the one or more of user tracking lists or advertising target lists, applying, with the second computer, internal data processing rules to ensure national policy adherence. In some embodiments, applying, with the second computer, internal data processing rules to ensure national policy adherence might comprise removing, with the second computer and from the one or more of user tracking lists or advertising target lists, all user identifiers associated with the particular user (block 340). According to some embodiments, post traffic collection processing mechanisms by an ISP, a government agency, or other third party group (rather than the web server associated with a website visited by the particular user, the advertiser, or the tracking company, or the like) might remove the particular user (and/or all user identifiers associated with the particular user) from the one or more of user tracking lists or advertising target lists.

In the embodiment of FIG. 3B, the processes at blocks 305-330 might be similar, if not identical to the processes at blocks 305-330 of FIG. 3A, except that the requesting party in the embodiment of FIG. 3B might be a government agency, a watchdog organization, or the like (rather than the website visited by the particular user, the advertiser, the tracking company, or the like). Method 300 might further comprise, at block 345, based on a determination that the one or more of the at least one user identifier associated with the particular user, another user identifier associated with the particular user, or the particular user are included in the one or more of user tracking lists or advertising target lists, reporting, with the second computer, one or more organizations associated with one or more of user tracking lists or advertising target lists (e.g., a web server associated with a website visited by the particular user, an advertiser, or a tracking company, or the like), as failing to comply with at least one of a do not track list or a do not advertise list. According to some embodiments, an ISP, the government agency, the watchdog organization, or other third party group might perform post traffic analysis to audit companies that track and/or advertise to users who are on the first list (i.e., do not track lists and/or do not advertise lists).

In the embodiment of FIG. 3C, the processes at blocks 305-315 might be similar, if not identical to the processes at blocks 305-315, as described above. In this set of embodiments, the requesting party might be any of the web server associated with the website visited by the particular user, the advertiser, the tracking company, the government agency, the watch dog organization, or other like entities or organizations. Method 300, at block 350, might further comprise receiving, with a third computer associated with the requesting party, the first notification and, at block 355, generating, with the third computer, a new code setting associated with the particular user, the new code setting including at least one of one or more do not track cookies or one or more do not advertise cookies. Method 300 might further comprise identifying, with the third computer, one or more user devices (e.g., user devices 105 or 110 of FIG. 1) that are associated with the particular user (block 360) and sending, with the third computer, the new code setting to each of the one or more user devices associated with the particular user (block 365). The new code setting (i.e., do not track cookies and/or do not advertise cookies, or the like) might block each of the user devices associated with the particular user from unwanted advertisements or unwanted tracking of the user. Where the do not track and/or do not advertise determination is performed at the advertiser/web server side or as a post traffic analysis by an ISP, government agency, or third party group as described above in previous embodiments, this set of embodiments seeks to cover a preemptive approach that additionally and/or alternatively sets up user devices to tell the web servers/advertisers (at initial interaction) not to track, or advertise to, the particular user.

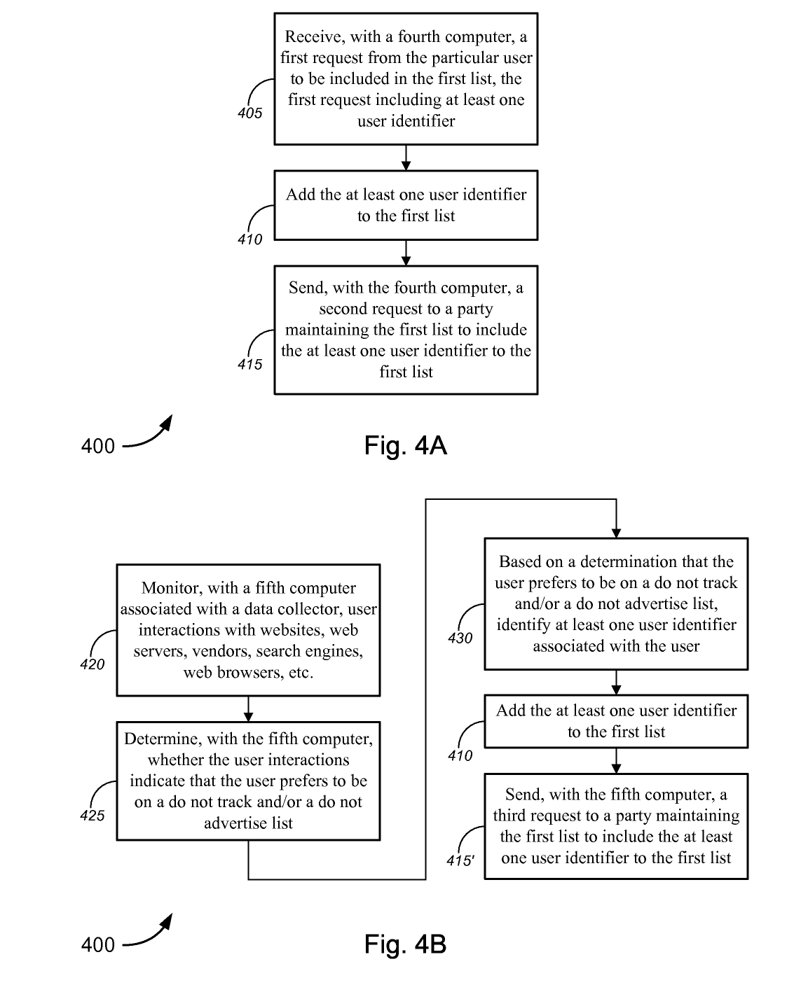

In the embodiments of FIG. 3, a key aspect might include that with the use of one or more user identifiers associated with the user (example as listed above), all user identifiers associated with the user may be identified and, if the user (or any of these user identifiers) is determined to be listed on do not track or do not advertise lists (whether local lists, national lists, or both), do not track and/or do not advertise functionalities and actions (as described above with respect to FIGS. 3A-3C) can be universally applied to the user and all user identifiers associated with the user. This differs, for example, for some national lists (e.g., do not call lists), in which do not call functionalities and actions are applied to only particular numbers already known to be associated with the user (and not any other numbers (or other user identifiers for that matter)). That leads to how to add one or more user identifiers to the first list, which is described in detail with respect to FIGS. 4A and 4B below.

FIGS. 4A and 4B (collectively, “FIG. 4”) are flow diagrams illustrating various methods 400 for adding at least one user identifier associated with a user to a do not track list or a do not advertise list, in accordance with various embodiments. FIG. 4A illustrates an example embodiment in which the user identifier(s) is added to the first list, in response to a request by a particular user, while FIG. 4B illustrates an example embodiment in which a data collector might monitor interactions between the user and various entities or organizations, and determines whether the user might like to be added to the first list.

While the techniques and procedures are depicted and/or described in a certain order for purposes of illustration, it should be appreciated that certain procedures may be reordered and/or omitted within the scope of various embodiments. Moreover, while the method illustrated by FIG. 4 can be implemented by (and, in some cases, are described below with respect to) the systems 100, 200, 800, and/or 900 of FIGS. 1, 2, 8, and/or 9, respectively (or components thereof), such methods may also be implemented using any suitable hardware implementation. Similarly, while each of the system 100 (and/or components thereof) of FIG. 1, the system 200 (and/or components thereof) of FIG. 2, the system 800 (and/or components thereof) of FIG. 8, and/or the system 900 (and/or components thereof) of FIG. 9 can operate according to the method illustrated by FIG. 4 (e.g., by executing instructions embodied on a computer readable medium), the systems 100, 200, 800, and 900 can each also operate according to other modes of operation and/or perform other suitable procedures.

In the embodiment of FIG. 4A, method 400 might comprise receiving, with a fourth computer, a first request from the particular user to be included in the first list (block 405). The first request might include at least one user identifier (examples of which are described above with respect to FIG. 3). At block 410, method 400 might further comprise adding the at least one user identifier to the first list (e.g., a do not track list and/or a do not advertise list, or the like). Method 400, at block 415, might comprise sending, with the fourth computer, a second request to a party maintaining the first list (e.g., a government agency registry or the like) to include the at least one user identifier to the first list, such as in the case where the entity associated with the fourth computer does not directly control or maintain the first list.

In the embodiment of FIG. 4B, the process at block 405 might be replaced by processes at block 420-430, as described below. Method 400 might comprise monitoring, with a fifth computer associated with a data collector, user interactions between a particular user and one or more of websites, web servers, vendors, search engines, web browsers, advertisers, tracking companies, and/or the like (block 420). At block 425, method 400 might comprise determining, with the fifth computer, whether the user interactions indicate that the user prefers to be on a do not track and/or a do not advertise list. For example, if the data collector monitors that the user, during registration with a vendor (on the vendor's website) or the like, typically unclicks checkboxes that when clicked would put the user on a mailing list (e.g., via physical mail, via e-mail, via text messaging, and/or the like) for newsletters, ads, coupons, etc., then the data collector might determine that the user does not want to be advertised to. In a similar manner, if the data collector monitors that the user, during installation of a software application (“app”) on the user's user device(s), typically selects (if possible) not to have her location tracked (or otherwise indicates that she would rather not have her location, browsing history, interactions with various entities or companies, or other actions tracked, or the like), then the data collector might determine that the user does not want to be tracked. In such cases, after ensuring the user is listed in a do not track list (i.e., first list), in accordance with blocks 410 or 415, the data collector might itself cease to track the user's interactions.

Method 400, at block 430, might comprise, based on a determination that the user prefers to be on a do not track and/or a do not advertise list, identify at least one user identifier associated with the user. The process might then proceed to block 410 (which is similar, if not identical to, block 410 of FIG. 4A). Thereafter, the process might proceed to block 415′, at which method 400 might comprise sending, with the fifth computer, a third request to a party maintaining the first list to include the at least one user identifier to the first list. Here, the process at block 415′ might be similar, if not identical to, the process at block 415 of FIG. 4A.

In FIG. 4, although at least one user identifier is added to the first list, the various embodiments are not so limited, and in some cases method 400 might further comprise determining all user identifiers associated with the user and adding (or requesting a party maintaining the first list to add) all user identifiers associated with the user to the first list.

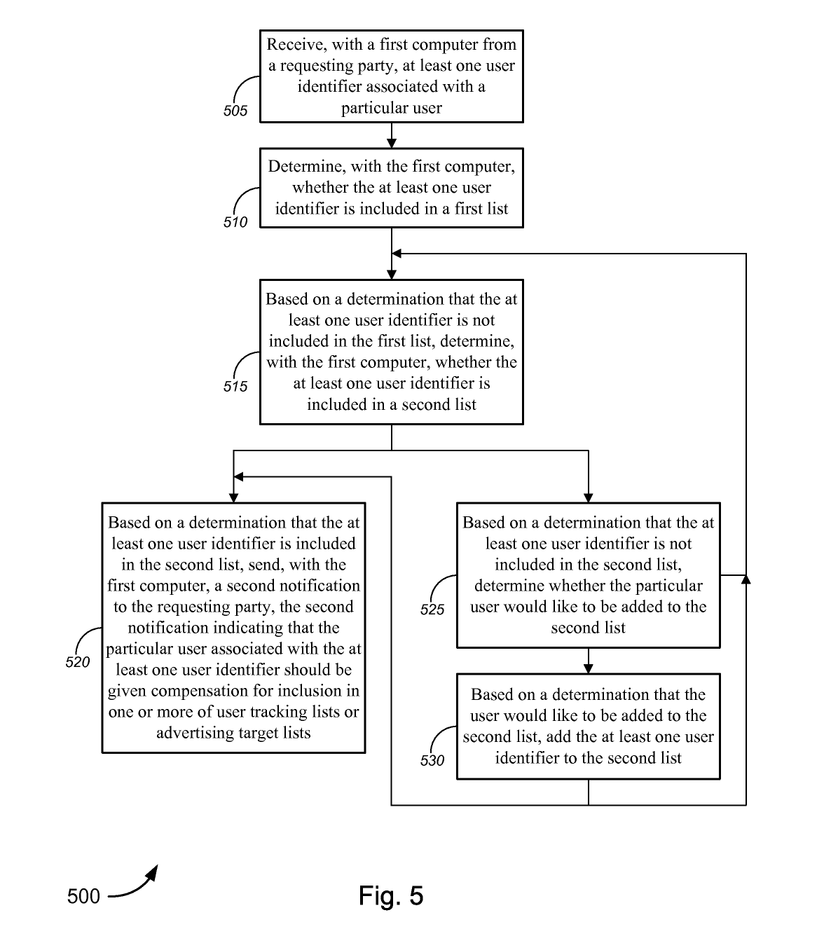

FIG. 5 is a flow diagram illustrating a method 500 for implementing “track me” or “advertise to me” functionality, in accordance with various embodiments. While the techniques and procedures are depicted and/or described in a certain order for purposes of illustration, it should be appreciated that certain procedures may be reordered and/or omitted within the scope of various embodiments. Moreover, while the method illustrated by FIG. 5 can be implemented by (and, in some cases, are described below with respect to) the systems 100, 200, 800, and/or 900 of FIGS. 1, 2, 8, and/or 9, respectively (or components thereof), such methods may also be implemented using any suitable hardware implementation. Similarly, while each of the system 100 (and/or components thereof) of FIG. 1, the system 200 (and/or components thereof) of FIG. 2, the system 800 (and/or components thereof) of FIG. 8, and/or the system 900 (and/or components thereof) of FIG. 9 can operate according to the method illustrated by FIG. 5 (e.g., by executing instructions embodied on a computer readable medium), the systems 100, 200, 800, and 900 can each also operate according to other modes of operation and/or perform other suitable procedures.

In FIG. 5, method 500 might comprise receiving, with a first computer from a requesting party, at least one user identifier associated with a particular user (block 505) and determining, with the first computer, whether the at least one user identifier is included in a first list (block 510). Here, blocks 505 and 510 might be similar, if not identical, to blocks 305 and 310 in FIG. 3.

At block 515, method 500 might comprise, based on a determination that the at least one user identifier is not included in the first list, determining, with the first computer, whether the at least one user identifier is included in a second list (e.g., a “track me” list and/or an “advertise to me” list, or the like). The process proceeds to one of blocks 520 or 525, based on such determination. For example, at block 520, method 500 might comprise, based on a determination that the at least one user identifier is included in the second list, sending, with the first computer, a second notification to the requesting party. The second notification might indicate that the particular user associated with the at least one user identifier should be given compensation for inclusion in one or more of user tracking lists or advertising target. Compensation may be determined as appropriate by an advertiser, a vendor, a tracking company, or the like.

According to some embodiments, compensation might include, but is not limited to, one or more of a promotion on products purchased by the particular user from a first company affiliated with the one or more of user tracking lists or advertising target lists or a promotion on services purchased by the particular user from the first company affiliated with the one or more of user tracking lists or advertising target lists. The promotion on products and the promotion on services might each include, without limitation, one or more of a discount on purchase of one or more of the products, a discount on purchase of one or more of the services, a subsidy for purchase of one or more of the products, a subsidy for purchase of one or more of the services, a discount on purchase of one or more products offered by a second company affiliated with the first company, a discount on purchase of one or more services offered by the second company affiliated with the first company, a subsidy on purchase of one or more products offered by a second company affiliated with the first company, or a subsidy on purchase of one or more services offered by the second company affiliated with the first company, and/or the like.

Alternatively, method 500, at block 525, might comprise based on a determination that the at least one user identifier is not included in the second list, determining whether the particular user would like to be added to the second list. To determine whether the particular user would like to be added to the second list, the user might be asked in a survey or other questionnaire-type interaction, or the user might be monitored in a manner not unlike that in the processes of blocks 420 and 425 of FIG. 4, except that (rather than determining whether the user would prefer to be on a do not track and/or a do not advertise list) the data collector might determine whether the user would prefer to be tracked or advertised to. For example, with respect to the examples described above with respect to block 425, the user might typically check the box indicating that she would like to receive newsletters, ads, coupons, etc. (i.e., would like to be put on the mailing list), or the user might typically select to have her location, browsing history, interactions with various entities or companies, and/or other actions tracked, or the like.

Method 500 might further comprise, based on a determination that the user would like to be added to the second list, add (or request a party maintaining the second list to add) the at least one user identifier to the second list (block 430). Thereafter, the process might either proceed to block 515 or to block 520.

Like with the embodiment of FIG. 4, in FIG. 5, although at least one user identifier is added to the second list, the various embodiments are not so limited, and in some cases method 500 might further comprise determining all user identifiers associated with the user and adding (or requesting a party maintaining the second list to add) all user identifiers associated with the user to the second list.

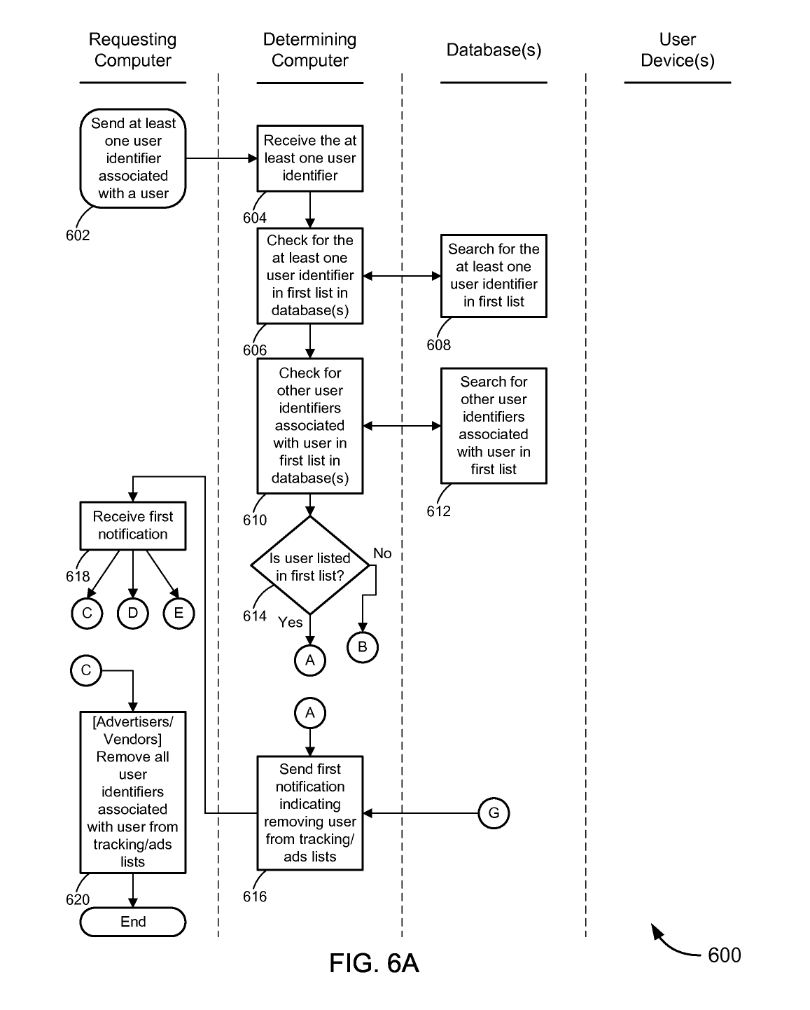

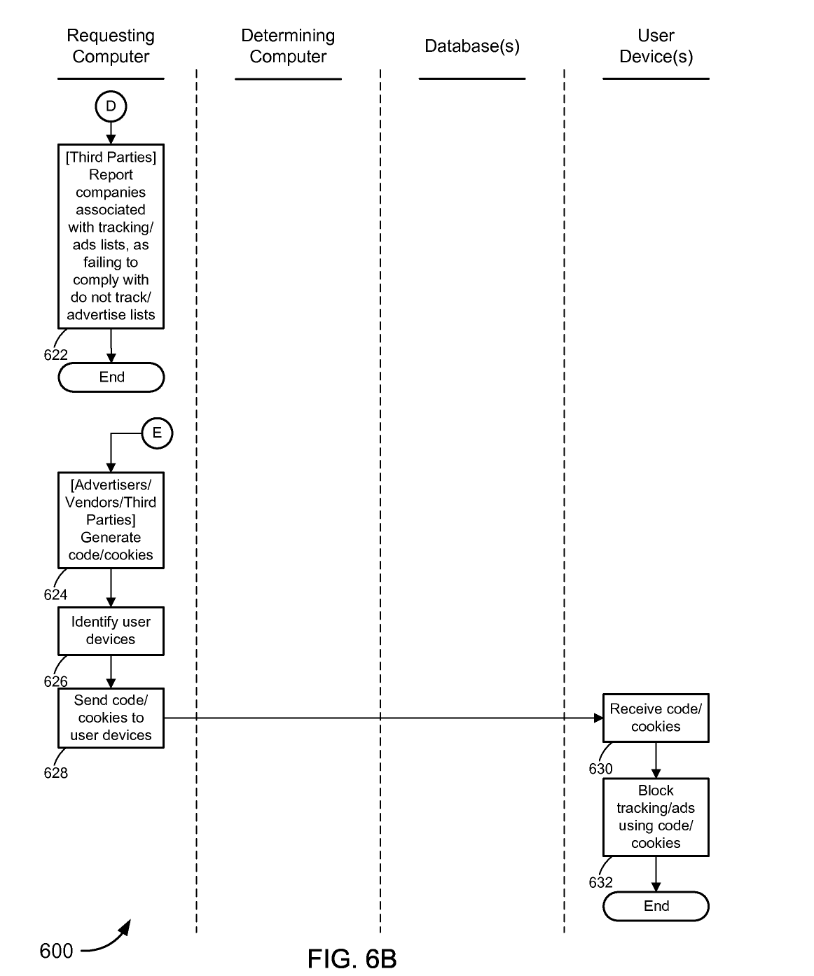

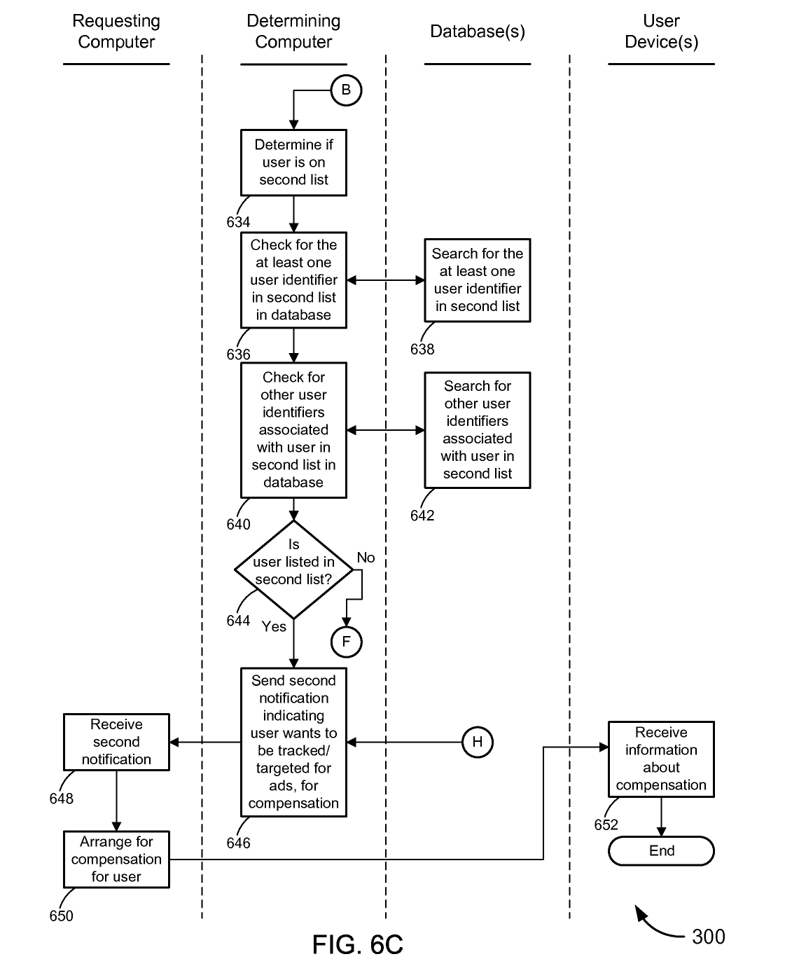

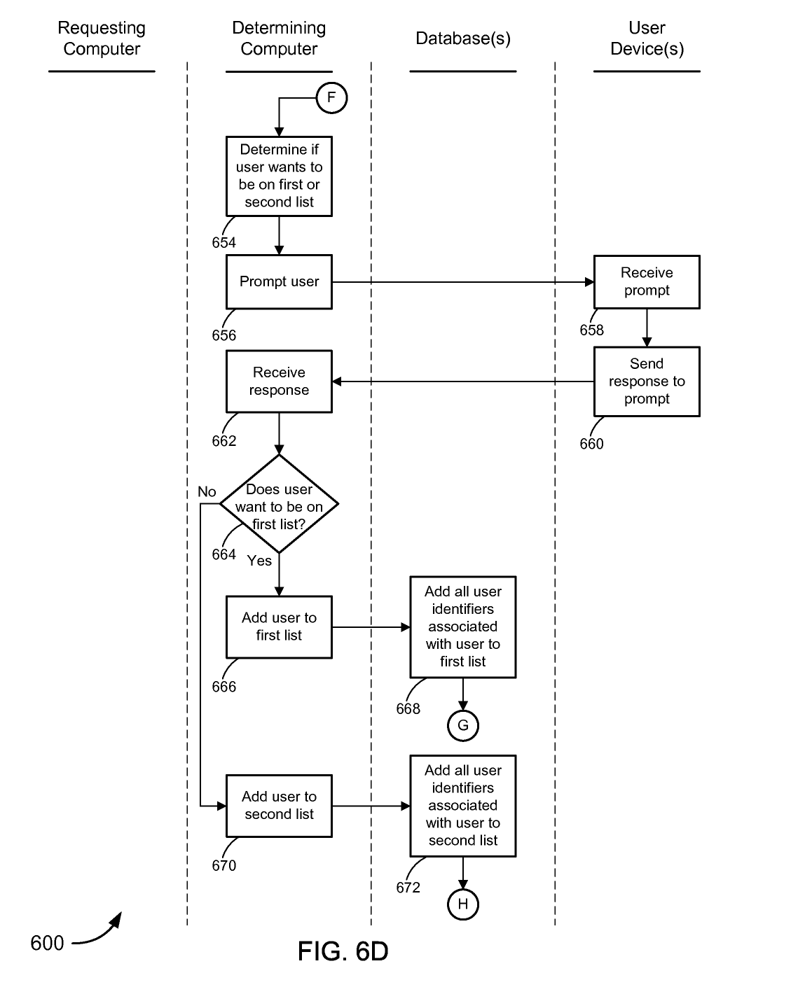

FIGS. 6A-6D (collectively, “FIG. 6”) represent a system flow diagram illustrating a method 600 for implementing do not track or do not advertise functionality and for implementing “track me” or “advertise to me” functionality, in accordance with various embodiments. The embodiments as represented in FIG. 6 are merely illustrative and are not intended to limit the scope of the various embodiments

With reference to FIG. 6, method 600 in FIG. 6A continues onto FIG. 6B, linked by circular markers denoted by “D” and “E,” continues from FIG. 6A to FIG. 6C, linked by circular marker denoted by “B,” continues from FIG. 6C to FIG. 6D, linked by circular marker denoted by “F.” Method 600 returns back to FIG. 6A from FIG. 6D, linked by circular marker denoted by “G,” and returns back to FIG. 6C from FIG. 6D, linked by circular marker denoted by “H.”

Turning to FIG. 6A, method 600 might comprise a requesting computer (which might be a computer or server associated with a requesting party, which might include one of an advertiser, a tracking company, a vendor (e.g., a website vendor or other vendor, etc.), a government agency, a watch dog group, and/or the like) might send at least one user identifier associated with a user (block 602), which might be received by a determining computer (which might be a computer or server associated with one or more of an Internet service provider, another service provider, a government agency, and/or the like) (block 604). At block 606, the determining computer might check for the at least one user identifier in a first list in one or more databases, which might involve interacting with the one or more databases, during which the one or more databases might search for the at least one user identifier in the first list (block 608) and return results of the search to the determining computer. In a similar manner, at block 610, the determining computer might check for other user identifiers associated with the user in the first list in the one or more databases, and during interactions with the one or more databases, the one or more databases might search for the other user identifiers associated with the user in the first list (block 612) and return results of the search to the determining computer. The one or more databases might be hardware-based (i.e., physically owned or maintained by the party other than the particular user) or cloud-based storage media.

Here, as above, the first list might include, but is not limited to, a local do not track list, a local do not advertise list, a national do not track list, and/or a national do not advertise list. Here also, as above, the at least one user identifier might be, for instance, a primary e-mail address, while the other user identifiers might, for example, include, but is not limited to, one or more of name of the user, usernames associated with the user, at least one telephone number associated with the user, one or more other e-mail addresses associated with the user, a social security number or tax identification number associated with the user, a tax identification number associated with the particular user, a passport number associated with the user, one or more bank account numbers associated with the user, one or more universal resource locator (“URL”) addresses associated with the user, one or more metadata associated with the user, one or more documents associated with the user, one or more devices (or device identifiers) associated with the user, one or more Internet protocol (“IP”) addresses associated with the user or associated with devices associated with the user, one or more media access control (“MAC”) addresses associated with the user or associated with devices associated with the user, and/or the like.

Method 600, at block 614, might comprise the determining computer determining (based on the returned search results) whether the user is listed in the first list. If so, the process continues to block 616, linked by circular marker denoted by “A.” If not, the process proceeds to block 634 in FIG. 6C, linked by circular marker denoted by “B.”

At block 616, method 600 might comprise the determining computer sending a first notification to the requesting computer, which might receive the first notification at block 618. The first notification might indicate that the user should be removed from (or should otherwise not be listed on) tracking or advertisement lists. Depending on the type of entity that the requesting party might be, the process might continue to different blocks. For instance, if the requesting party is an advertiser, a tracking company, or a vendor, or the like, the process continues to either block 620, linked by circular marker denoted by “C,” or block 624 in FIG. 6B, linked by circular marker denoted by “E.” On the other hand, if the requesting party is a third party (e.g., a government agency or a non-government agency (which might include, but is not limited to, private or public companies, watch-dog groups, for profit or non-profit companies, and/or the like)), the process continues to either block 622 in FIG. 6B, linked by circular marker denoted by “D,” or block 624 in FIG. 6B, linked by circular marker denoted by “E.”

At block 620 in FIG. 6A, the requesting computer (which might be associated with a requesting party such as an advertiser, a tracking company, or a vendor, or the like) might remove all user identifiers associated with the user from all tracking lists or all advertisement lists to which the requesting computer has control (or otherwise maintains). Thereafter, the process might end.

At block 622 in FIG. 6B, the requesting computer (which might be associated with a requesting party such as a government agency, a private or public company, a watch-dog group, a for profit or non-profit company, or the like) might report companies as failing to comply with do not track and/or do not advertise lists, particularly when such companies are associated with tracking lists and/or advertisement lists that continue to list the user (and/or one or more user identifiers associated with the user) despite the user (and/or user identifiers associated with the user) being listed in the first list (i.e., local/national do not track/do not advertise list(s)). Thereafter, the process might end.

At block 624 in FIG. 6B, the requesting computer (which might be associated with a requesting party such as an advertiser, a tracking company, a vendor, a government agency, a private or public company, a watch-dog group, a for profit or non-profit company, or the like) might generate codes or cookies. The requesting computer might subsequently identify one or more user devices associated with the user (block 626) and might send the one or more codes or cookies to the one or more identified user devices (block 628). At block 630, the one or more user devices might receive the codes or cookies, and might install such codes or cookies thereon. At block 632, the one or more user devices might block future tracking or advertisement using the codes or cookies. Thereafter, the process might end.

We now turn to block 634, after determining that the user is not on the first list and following the circular marker denoted “B” from FIG. 6A to FIG. 6C. At block 634, the determining computer might determine whether the user is listed on the second list (which might be a “track me” or “advertise to me” list). Method 600, at block 636 might comprise the determining computer checking for the at least one user identifier in the second list in the one or more databases. During interactions between the determining computer and the one or more databases, the one or more databases might search for the at least one user identifier in the second list (block 638) and might return any results of the search to the determining computer. The determining computer, at block 640 might check for other user identifiers in the second list in the one or more databases. During interactions between the determining computer and the one or more databases, the one or more databases might search for the other user identifiers in the second list (block 642) and might return any results of the search to the determining computer.

At block 644, the determining computer might determine whether the user is listed in the second list. If so, the process continues to block 646. If not, the process proceeds to block 654 in FIG. 6D, linked by circular marker denoted by “F.”

Method 600, at block 646, might comprise the determining computer sending a second notification to the requesting computer, which might receive the second notification at block 648. The second notification might indicate that the user is listed on the second list, which further indicates that the user would like to (or wants to) be tracked and/or advertised to in exchange for some compensation (which may or may not be recorded together with the user identifier(s) in the second list. At block 650, the requesting computer might arrange for compensation for the user. This might include the requesting party (if directly or indirectly tracking, or advertising to, the user) to directly arrange compensation for the user (which might be based on a pre-arranged agreement between the requesting party and the user, or might be based on standard policies of the requesting party with respect to compensation for tracking and/or advertising to users). In some cases, arranging for compensation for the user might include the requesting party (if not directly or indirectly tracking, or advertising to, the user) requesting or forcing advertiser(s), tracking company(ies), and/or vendor(s), or the like to compensate the user for being tracked, or advertised to, by advertiser(s), tracking company(ies), and/or vendor(s), or the like. At block 652, the user device(s) might receive information about compensation (either from the requesting party or from an advertiser/tracker/vendor who is not the requesting party), which might include how to redeem coupons, discounts, rebates, or other forms of compensation, or the like. The process might subsequently end.

We now turn to block 654 in FIG. 6D, following circular marker denoted by “F” from FIG. 6C. If the user is not listed in the second list, at block 654, the determining computer might determine whether the user wants to or would like to be on the first or second list. At block 656, the determining computer might prompt the user, which prompt might be received by the user device(s) associated with the user (block 658). The user might send a response to the prompt (block 660), which might be received by the determining computer (block 662). The determining computer might then determine based on the response from the user whether the user would like to be listed on the first list (block 664). If so, the process continues to block 666, at which the determining computer might add the user to the first list, which might include the one or more databases adding all user identifiers associated with the user to the first list (block 668). The process might then return to block 616 in FIG. 6A, following the circular marker denoted by “G,” and proceeds as described above. If not, the process continues to block 670, at which the determining computer might add the user to the second list, which might include the one or more databases adding all user identifiers associated with the user to the second list (block 672). The process might then return to block 646 in FIG. 6C, following the circular marker denoted by “H,” and proceeds as described above.

The embodiments of FIGS. 3-6 as described above are directed to the use of one or more user identifiers associated with a user (among a plurality of user identifiers associated with the user) to determine whether or not the user should be tracked or not and/or advertised to or not. However, the various embodiments are not so limited. The one or more user identifiers associated with a user (among a plurality of user identifiers associated with the user) may also be used to determine whether particular documents may be associated with a particular user. Such information may be useful in determine, such as in the context of situations involving employees (in a non-limiting example), whether the employer (either current or former) has rights to the documents and/or other information, whether the employee (either current or former) has rights to the documents and/or other information, and so forth. Similarly, such determinations and actions (as described in detail below with respect to FIG. 7) may also be applicable to situations involving schools and former students, schools and guests, companies and visitors, banks and former customers, and the like, so long as state and federal laws do not already have specific guidelines as to how to handle documents and other information.

FIG. 7 is a flow diagram illustrating a method 700 for implementing document handling with respect to documents associated with particular users, in accordance with various embodiments. At block 705, method 700 might comprise receiving, with a first computer from a requesting party, at least one user identifier associated with a particular user. Method 700, at block 710, might comprise identifying, with the first computer, one or more first documents (or other information) associated with the particular user that are stored in one or more data stores, based at least in part on the received at least one user identifier. The one or more data stores might be associated with a party other than the particular user, and the one or more data stores may be hardware-based (i.e., physically owned or maintained by the party other than the particular user) or cloud-based storage media. In some embodiments, the party other than the particular user might be an employer of the particular user or a former employer of the particular user. In some cases, the party other than the particular user might be a bank and the particular user might be a current customer or a former customer of the bank, and the bank has documents or other information associated with the particular user. In some instances, the party other than the particular user might be a school and the particular user might be a current student or a former student, and the school had (when the particular student was a student) allowed the particular user to stored documents or information/data on the one or more data stores. In some embodiments, the party other than the particular user might be a company and the particular user might be a non-employee guest of the company who (when visiting the company) was allowed to store documents and/or information/data on the one or more data stores. And so on.

Method 700 might further comprise identifying, with the first computer, one or more second documents to which the party other than the particular user has rights (block 715). The one or more second documents might be identified from among the one or more first documents. At block 720, method 700 might comprise receiving, with the first computer, a request from the party other than the particular user to block access by the particular user to the one or more second documents stored in the one or more data stores. Method 700, at block 725, might comprise preventing, with the first computer, access by the particular user to the one or more second documents stored in the one or more data stores, in response to receiving, from the party other than the particular user, the request to block access.

According to some embodiments, the method 700 might further comprise, at block 730, identifying, with the first computer, one or more third documents to which the party other than the particular user has no rights. The one or more third documents might be identified from among the one or more first documents. At block 700, method 700 might comprise deleting, with the first computer, the one or more third documents from the one or more data stores—particularly, in the cases where the particular user is no longer associated with the party other than the particular user (i.e., in the context of former employment, former banking relationship, former student relationship, former guest relationship, and so on). Alternatively, in some embodiments, particularly in the cases whether there remains a current relationship between the particular user and the party other than the particular user (i.e., in the context of current employment, current banking relationship, current student relationship, current guest relationship, and so on), the first computer might establish a secure portion of the one or more data stores that is accessible only by the particular user (e.g., by use of passwords, pass keys, etc.) (block 735), moving the one or more third documents to the secure portion of the one or more data stores, and providing the particular user with access to, or options to access, the secure portion of the one or more data stores.

We now turn to FIG. 8, which is a block diagram illustrating an exemplary computer architecture. FIG. 8 provides a schematic illustration of one embodiment of a computer system 800 that can perform the methods provided by various other embodiments, as described herein, and/or can perform the functions of local computer system 105 or 110, or remote (or, in some cases, cloud) computing system 115, 135, 145, 155, or 170, or other computer systems as described above. It should be noted that FIG. 8 is meant only to provide a generalized illustration of various components, of which one or more, or none, of each may be utilized as appropriate. FIG. 8, therefore, broadly illustrates how individual system elements may be implemented in a relatively separated or relatively more integrated manner.

The computer system 800 is shown comprising hardware elements that can be electrically coupled via a bus 805, or may otherwise be in communication, as appropriate. The hardware elements may include one or more processors 810, including, without limitation, one or more general-purpose processors, or one or more special-purpose processors such as digital signal processing chips, graphics acceleration processors, or the like; one or more input devices 815, which can include, without limitation, a mouse, a keyboard, or the like; and one or more output devices 820, which can include, without limitation, a display device, a printer, or the like.

The computer system 800 may further include, or be in communication with, one or more storage devices 825. The one or more storage devices 825 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including, without limitation, various file systems, database structures, or the like.

The computer system 800 might also include a communications subsystem 830, which can include, without limitation, a modem, a network card (wireless or wired), an infra-red communication device, a wireless communication device or chipset, or the like. The wireless communication device might include, but is not limited to, a Bluetooth™ device, an 802.11 device, a WiFi device, a WiMax device, a WWAN device, cellular communication facilities, or the like.

The communications subsystem 830 may permit data to be exchanged with a network (such as network 120 or 215, to name a few examples), with other computer systems, with any other devices described herein, or with any combination of network, systems, and devices. According to some embodiments, network 120 (or network 215) might include a local area network (“LAN”), including, without limitation, a fiber network, an Ethernet network, a Token-RingTm network, and the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol, or any other wireless protocol; or any combination of these or other networks. In many embodiments, the computer system 800 will further comprise a working memory 835, which can include a RAM or ROM device, as described above.

The computer system 800 may also comprise software elements, shown as being currently located within the working memory 835, including an operating system 840, device drivers, executable libraries, or other code. The software elements may include one or more application programs 845, which may comprise computer programs provided by various embodiments, or may be designed to implement methods and/or configure systems provided by other embodiments, as described herein. Merely by way of example, one or more procedures described with respect to the methods discussed above might be implemented as code or instructions executable by a computer or by a processor within a computer. In an aspect, such code or instructions can be used to configure or adapt a general purpose computer, or other device, to perform one or more operations in accordance with the described methods.

A set of these instructions or code might be encoded and/or stored on a non-transitory computer readable storage medium, such as the storage devices 825 described above. In some cases, the storage medium might be incorporated within a computer system, such as the system 800. In other embodiments, the storage medium might be separate from a computer system—that is, a removable medium, such as a compact disc, or the like. In some embodiments, the storage medium might be provided in an installation package, such that the storage medium can be used to program, configure, and/or adapt a general purpose computer with the instructions/code stored thereon. These instructions might take the form of executable code, which is executable by the computer system 800, or might take the form of source or installable code. The source or installable code, upon compilation, installation, or both compilation and installation, on the computer system 800 might take the form of executable code. Compilation or installation might be performed using any of a variety of generally available compilers, installation programs, compression/decompression utilities, or the like.

It will be apparent to those skilled in the art that substantial variations may be made in accordance with specific requirements. For example, customized hardware—such as programmable logic controllers, field-programmable gate arrays, application-specific integrated circuits, or the like—might also be used. In some cases, particular elements might be implemented in hardware, software (including portable software, such as applets, etc.), or both. Further, connection to other computing devices such as network input/output devices may be employed.

As mentioned above, in one aspect, some embodiments may employ a computer system, such as the computer system 800, to perform methods in accordance with various embodiments of the invention. According to a set of embodiments, some or all of the procedures of such methods might be performed by the computer system 800 in response to processor 810 executing one or more sequences of one or more instructions. The one or more instructions might be incorporated into the operating system 840 or other code that may be contained in the working memory 835, such as an application program 845. Such instructions may be read into the working memory 835 from another computer readable medium, such as one or more of the storage devices 825. Merely by way of example, execution of the sequences of instructions contained in the working memory 835 might cause the one or more processors 810 to perform one or more procedures of the methods described herein.

The terms “machine readable medium” and “computer readable medium,” as used herein, refer to any medium that participates in providing data that causes a machine to operate in a specific fashion. In an embodiment implemented using the computer system 800, various computer readable media might be involved in providing instructions or code to the one or more processors 810 for execution, might be used to store and/or carry such instructions/code such as signals, or both. In many implementations, a computer readable medium is a non-transitory, physical, or tangible storage medium. Such a medium may take many forms, including, but not limited to, non-volatile media, volatile media, and transmission media. Non-volatile media includes, for example, optical disks, magnetic disks, or both, such as the storage devices 825. Volatile media includes, without limitation, dynamic memory, such as the working memory 835. Transmission media includes, without limitation, coaxial cables, copper wire and fiber optics, including the wires that comprise the bus 805, as well as the various components of the communication subsystem 830, or the media by which the communications subsystem 830 provides communication with other devices. Hence, transmission media can also take the form of waves, including, without limitation, radio, acoustic, or light waves, such as those generated during radio-wave and infra-red data communications.

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium with patterns of holes; a RAM, a PROM, an EPROM, a FLASH-EPROM, or any other memory chip or cartridge; a carrier wave; or any other medium from which a computer can read instructions or code.

As noted above, a set of embodiments comprises methods and systems for implementing do not track or do not advertise functionality, for implementing “track me” or “advertise to me” functionality, and/or for implementing document handling in the case of documents associated with particular users, in some cases via use of web browsers. FIG. 9 illustrates a schematic diagram of a system 900 that can be used in accordance with one set of embodiments. The system 900 can include one or more user computers or user devices 905. A user computer or user device 905 can be a general purpose personal computer (including, merely by way of example, desktop computers, tablet computers, laptop computers, handheld computers, and the like, running any appropriate operating system, several of which are available from vendors such as Apple, Microsoft Corp., and the like) and/or a workstation computer running any of a variety of commercially-available UNIX™ or UNIX-like operating systems. A user computer or user device 905 can also have any of a variety of applications, including one or more applications configured to perform methods provided by various embodiments (as described above, for example), as well as one or more office applications, database client and/or server applications, and/or web browser applications. Alternatively, a user computer or user device 905 can be any other electronic device, such as a thin-client computer, Internet-enabled mobile telephone, and/or personal digital assistant, capable of communicating via a network (e.g., the network 910 described below) and/or of displaying and navigating web pages or other types of electronic documents. Although the exemplary system 900 is shown with three user computers or user devices 905, any number of user computers or user devices can be supported.

Certain embodiments operate in a networked environment, which can include a network 910. The network 910 can be any type of network familiar to those skilled in the art that can support data communications using any of a variety of commercially-available (and/or free or proprietary) protocols, including, without limitation, TCP/IP, SNA™ IPX™ AppleTalk™, and the like. Merely by way of example, the network 910 can include a local area network (“LAN”), including, without limitation, a fiber network, an Ethernet network, a Token-Ring™ network and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 915. Each of the server computers 915 may be configured with an operating system, including, without limitation, any of those discussed above, as well as any commercially (or freely) available server operating systems. Each of the servers 915 may also be running one or more applications, which can be configured to provide services to one or more clients 905 and/or other servers 915.

Merely by way of example, one of the servers 915 might be a data server, as described above. The data server might include (or be in communication with) a web server, which can be used, merely by way of example, to process requests for web pages or other electronic documents from user computers 905. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 905 to perform methods of the invention.

The server computers 915, in some embodiments, might include one or more application servers, which can be configured with one or more applications accessible by a client running on one or more of the client computers 905 and/or other servers 915. Merely by way of example, the server(s) 915 can be one or more general purpose computers capable of executing programs or scripts in response to the user computers 905 and/or other servers 915, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™ IBM™, and the like, which can process requests from clients (including, depending on the configuration, dedicated database clients, API clients, web browsers, etc.) running on a user computer or user device 905 and/or another server 915. In some embodiments, an application server can perform one or more of the processes for implementing do not track or do not advertise functionality, or the like, as described in detail above. Data provided by an application server may be formatted as one or more web pages (comprising HTML, JavaScript, etc., for example) and/or may be forwarded to a user computer 905 via a web server (as described above, for example). Similarly, a web server might receive web page requests and/or input data from a user computer 905 and/or forward the web page requests and/or input data to an application server. In some cases, a web server may be integrated with an application server.

In accordance with further embodiments, one or more servers 915 can function as a file server and/or can include one or more of the files (e.g., application code, data files, etc.) necessary to implement various disclosed methods, incorporated by an application running on a user computer 905 and/or another server 915. Alternatively, as those skilled in the art will appreciate, a file server can include all necessary files, allowing such an application to be invoked remotely by a user computer or user device 905 and/or server 915.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 920. The location of the database(s) 920 is discretionary: merely by way of example, a database 920a might reside on a storage medium local to (and/or resident in) a server 915a (and/or a user computer or user device 905). Alternatively, a database 920b can be remote from any or all of the computers 905, 915, so long as it can be in communication (e.g., via the network 910) with one or more of these. In a particular set of embodiments, a database 920 can reside in a storage-area network (“SAN”) familiar to those skilled in the art. (Likewise, any necessary files for performing the functions attributed to the computers 905, 915 can be stored locally on the respective computer and/or remotely, as appropriate.) In one set of embodiments, the database 920 can be a relational database, such as an Oracle database, that is adapted to store, update, and retrieve data in response to SQL-formatted commands. The database might be controlled and/or maintained by a database server, as described above, for example.

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 900. These signals, which might be in the form of electromagnetic signals, acoustic signals, optical signals, and/or the like, are all examples of carrier waves on which instructions can be encoded, in accordance with various embodiments of the invention.

The communications subsystem 930 (and/or components thereof) generally will receive the signals, and the bus 905 then might carry the signals (and/or the data, instructions, etc. carried by the signals) to the working memory 935, from which the processor(s) 905 retrieves and executes the instructions. The instructions received by the working memory 935 may optionally be stored on a storage device 925 either before or after execution by the processor(s) 910.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a first computer from a requesting party, at least one user identifier associated with a particular user;
determining, with the first computer, whether the at least one user identifier is included in a first list; and
based on a determination that the at least one user identifier is included in the first list, sending, with the first computer, a first notification to the requesting party, the first notification indicating that the particular user associated with the at least one user identifier should be removed from one or more of user tracking lists or advertising target lists.

2. The method of claim 1, wherein the first computer is a server operated by an Internet service provider, and is located within a network associated with the Internet service provider.

3. The method of claim 1, wherein the first computer is a computer associated with a government agency registry of at least one of do not advertise user identities or do not track user identities.

4. The method of claim 1, wherein the requesting party is a web server associated with a website visited by the particular user.

5. The method of claim 1, wherein the requesting party is an advertiser affiliated with companies with which the particular user has interacted to search, inquire, or purchase products or services offered by the companies.

6. The method of claim 1, wherein the at least one user identifier includes one or more identification information selected from a group consisting of one or more names of the particular user, one or more usernames of the particular user, one or more telephone numbers associated with the particular user, one or more e-mail addresses associated with the particular user, a social security number associated with the particular user, a tax identification number associated with the particular user, a passport number associated with the particular user, one or more bank accounts associated with the particular user, one or more universal resource locator addresses associated with the particular user, one or more metadata associated with the particular user, one or more documents associated with the particular user, one or more devices associated with the particular user, one or more device identifiers associated with a device associated with the particular user, one or more Internet protocol (“IP”) addresses associated with devices associated with the particular user, one or more Internet protocol addresses associated with the particular user, and one or more media access control addresses associated with at least one device associated with the particular user.

7. The method of claim 1, wherein the first list is at least one of a national do not track list or a national do not advertise list.

8. The method of claim 1, wherein the first list is at least one of a local do not track list or a local do not advertise list.

9. The method of claim 8, wherein the at least one of a local do not track list or a local do not advertise list is maintained by an Internet service provider.

10. The method of claim 1, further comprising:
receiving, with a second computer associated with the requesting party, the first notification;
accessing, with the second computer, the one or more of user tracking lists or advertising target lists;
determining, with the second computer, whether one or more of the at least one user identifier associated with the particular user, another user identifier associated with the particular user, or the particular user are included in the one or more of user tracking lists or advertising target lists.

11. The method of claim 10, further comprising:
based on a determination that the one or more of the at least one user identifier associated with the particular user, another user identifier associated with the particular user, or the particular user are included in the one or more of user tracking lists or advertising target lists, applying, with the second computer, internal data processing rules to ensure national policy adherence.

12. The method of claim 11, wherein applying, with the second computer, internal data processing rules to ensure national policy adherence comprises removing, with the second computer and from the one or more of user tracking lists or advertising target lists, all user identifiers associated with the particular user.

13. The method of claim 10, further comprising:
based on a determination that the one or more of the at least one user identifier associated with the particular user, another user identifier associated with the particular user, or the particular user are included in the one or more of user tracking lists or advertising target lists, reporting, with the second computer, one or more organizations associated with one or more of user tracking lists or advertising target lists, as failing to comply with at least one of a do not track list or a do not advertise list.

14. The method of claim 1, further comprising:
receiving, with a third computer associated with the requesting party, the first notification;
generating, with the third computer, a new code setting associated with the particular user, the new code setting including at least one of one or more do not track cookies or one or more do not advertise cookies;
identifying, with the third computer, one or more user devices associated with the particular user; and
sending, with the third computer, the new code setting to each of the one or more user devices associated with the particular user.

15. The method of claim 1, further comprising:
receiving, with a fourth computer, a first request from the particular user to be included in the first list, the first request including the at least one user identifier;
adding the at least one user identifier to the first list.

16. The method of claim 15, wherein adding the at least one user identifier to the first list comprises sending, with the fourth computer, a second request to a party maintaining the first list to include the at least one user identifier to the first list.

17. The method of claim 1, further comprising:
based on a determination that the at least one user identifier is not included in the first list, determining, with the first computer, whether the at least one user identifier is included in a second list;
based on a determination that the at least one user identifier is included in the second list, sending, with the first computer, a second notification to the requesting party, the second notification indicating that the particular user associated with the at least one user identifier should be given compensation for inclusion in one or more of user tracking lists or advertising target lists.

18. The method of claim 17, wherein the compensation includes one or more of a promotion on products purchased by the particular user from a first company affiliated with the one or more of user tracking lists or advertising target lists or a promotion on services purchased by the particular user from the first company affiliated with the one or more of user tracking lists or advertising target lists, wherein the promotion on products and the promotion on services each includes one or more of a discount on purchase of one or more of the products, a discount on purchase of one or more of the services, a subsidy for purchase of one or more of the products, a subsidy for purchase of one or more of the services, a discount on purchase of one or more products offered by a second company affiliated with the first company, a discount on purchase of one or more services offered by the second company affiliated with the first company, a subsidy on purchase of one or more products offered by a second company affiliated with the first company, or a subsidy on purchase of one or more services offered by the second company affiliated with the first company.

19. An apparatus, comprising:
at least one processor; and
at least one non-transitory computer readable medium having encoded thereon software, the software including a set of instructions that, when executed by the at least one processor, causes the apparatus to perform one or more operations, the set of instructions comprising:
instructions to receive, from a requesting party, at least one user identifier associated with a particular user;
instructions to determine whether the at least one user identifier is included in a first list; and
instructions to send, based on a determination that the at least one user identifier is included in the first list, a first notification to the requesting party, the first notification indicating that the particular user associated with the at least one user identifier should be removed from one or more of user tracking lists or advertising target lists.

20. A method, comprising:
receiving, with a first computer from a requesting party, at least one user identifier associated with a particular user;
identifying, with the first computer, one or more first documents associated with the particular user that are stored in one or more data stores, based at least in part on the received at least one user identifier, the one or more data stores being associated with a party other than the particular user;
identifying, with the first computer, one or more second documents to which the party other than the particular user has rights, the one or more second documents being identified from among the one or more first documents;
receiving, with the first computer, a request from the party other than the particular user to block access by the particular user to the one or more second documents stored in the one or more data stores; and
preventing, with the first computer, access by the particular user to the one or more second documents stored in the one or more data stores, in response to receiving, from the party other than the particular user, the request to block access.

21. The method of claim 20, further comprising:
identifying, with the first computer, one or more third documents to which the party other than the particular user has no rights, the one or more third documents being identified from among the one or more first documents;
deleting, with the first computer, the one or more third documents from the one or more data stores.

22. The method of claim 20, further comprising:
identifying, with the first computer, one or more third documents to which the party other than the particular user has no rights, the one or more third documents being identified from among the one or more first documents;
establishing, with the first computer, one or more secure portions of the one or more data stores;
moving, with the first computer, the one or more third documents to the one or more secure portions of the one or more data stores; and
providing the user with access to the one or more secure portions of the one or more data stores.

23. The method of claim 20, wherein the party other than the particular user comprises one of an employer of the particular user, a former employer of the particular user, a bank serving the particular user who is a customer of the bank, a bank serving the particular user who is a former customer of the bank, a school that allows the particular user as a student to store documents or data, or a school that had allowed the particular user to store documents or data when the particular user was a student.
